(19) United States
(12) Patent Application Publication
(10) Pub. No.: US 2008/0201209 A1
(43) Pub. Date: Aug. 21, 2008

(54) Computer assisted process for providing liquidity by sale of intellectual property trust certificates

(75) Inventor: Patrick Grotto, Sharon, CT (US)

Correspondence Address: SEYFARTH SHAW, LLP, 815 CONNECTICUT AVENUE, N.W., SUITE 500, WASHINGTON, DC, 20006, US

(73) Assignee: Ipie Mae Corporation

(21) Appl. No.: 12/071,019

(22) Filed: Feb. 14, 2008

Related U.S. Application Data
(60) Provisional application No. 60/901,308, filed on Feb. 15, 2007.

(51) Int. Cl. G06Q 40/00; G06Q 10/00; G06Q 30/00; G06F 7/06; G06F 17/30

(52) U.S. Cl. 705/10; 705/37; 705/36 R; 705/30; 707/5; 707/E17.017

(57) ABSTRACT

A computer program storing computer instructions therein for instructing a computer to perform analytical steps for the centralized public sale of intellectual property trust certificates issuing from the securitization of intellectual property assets, the securitization initiated by an analytical entity and managed by a management company, the securities sold as intellectual property trust certificates to an investor having access to a central database by a banking institution and the program comprising: a recording medium readable by the computer; and the computer instructions stored on said recording medium instructing the computer to perform the processes including: reporting to the central database an evaluation report of the aggregation for soliciting investment; reporting to the central database a title certificate; reporting to the central database a licensing agreement report for the aggregation for licensing intellectual property assets to licensees; reporting to the central database a description of an intellectual property securitization fund for guaranteeing the intellectual property trust certificates; reporting to the central database a royalties receivable report for the aggregation; reporting to the central database an intellectual property securitization fund statement; reporting to the central database a surveillance report; and reporting to the central database an intellectual property trust certificate chain of title report.

This invention claims the benefit of a provisional patent application 60/901,308 filed with the U.S. Patent and Trademark Office on Feb. 15, 2007, which is hereby incorporated by reference in its entirety.

### BACKGROUND OF THE INVENTION

The embodiments of the invention relate to a computer assisted process providing liquidity to an enterprise, and more particularly, to a computer assisted process for providing liquidity by in sale of intellectual property trust certificates. Although embodiments of the invention are suitable for a wide scope of applications, they are particularly suitable for the securitization of intellectual property assets, such as patents or trademarks.

Traditionally, securitization has been defined as a device where an entity seeks to aggregate together its interest in cash flows over time, transfer the cash flows to investors and thereby achieve financing. In this instance, the entity securitizing its assets is not actually borrowing money. Rather, by securitizing the entity is in fact selling cash that would otherwise accrue. In its simplest form, asset securitization is the conversion of assets or cash flow into marketable securities which are referred to as Asset-Backed Securities (ABS). The conceptual development of the ABS market dates back to the early 1970s when the Government National Mortgage Association (Ginnie Mae) issued a pool of securities backed by residential mortgages called Ginnie Mae Pool No. 1.

Asset aggregation is essential to the ABS concept. Asset aggregation makes otherwise minor and uneconomical investments worthwhile and simultaneously reduces risk by diversifying assets. Securitization opens up the asset pool or aggregation, typically composed of highly illiquid assets, to a broader pool of potential investors. Generally, illiquid assets are not easily traded. Aggregating these illiquid assets allows conversion to instruments that can be offered and sold more freely in capital markets.

A number of different types of assets may be used to create ABS aggregation. Over the past decade, there has been an increased interest in securitizing intellectual property assets. Intellectual property is increasingly recognized as a valuable component of a company's asset portfolio and as a potential for strategic investments. Companies are now commonly exploiting their patents for external financing and attracting venture capital. Even traditionally minded banks are beginning to accept patents as loan collateral. Some banks are developing intellectual property-backed securities specifically to enable patent holders access to financing. However, this activity is relatively recent and the total market share of intellectual property-backed securitization remains relatively small.

Intellectual asset management (IAM) has also received growing attention from the business community. Broadly speaking, IAM involves increasing the business value of intellectual property assets through more comprehensive valuation and management. Typically in IAM, patents which are not used for internal development are identified for external licensing without risking the company's profitability. Companies may also generate cost savings or tax benefits from either abandoning certain intellectual property assets outright or donation to no-profit organizations. In the latter case, the intellectual property abandoned or donated would typically be intellectual property the company does not plan to commercialize or relate directly to its core business or technology. In IAM, ABSs relating directly to intellectual property may be sold as securities. Alternatively, an intellectual property trust or securitization fund may be set up allowing the sale of intellectual property trust certificates.

### SUMMARY OF THE INVENTION

Accordingly, embodiments of the invention are directed to a computer assisted process providing liquidity to an enterprise by utilizing intellectual property assets that substantially obviates one or more of the problems due to limitations and disadvantages of the related art.

An object of embodiments of the invention is to provide a computer assisted process providing liquidity to an enterprise through the creation and centralized public sale of intellectual property asset backed securities as intellectual property trust certificates.

Another object of embodiments of the invention is to provide a computer assisted process providing liquidity to an enterprise through aggregating a series of intellectual property asset backed securities as intellectual property trust certificates, tranching the securities into classes and selling the securities in a centralized and public manner based on the tranches.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, the computer assisted process for providing liquidity to an enterprise by utilizing intellectual property assets includes a computer program storing computer instructions therein for instructing a computer to perform analytical steps for the centralized public sale of intellectual property trust certificates issuing from the securitization of intellectual property assets, the securitization initiated by an analytical entity and managed by a management company, the securities sold as intellectual property trust certificates to an investor having access to a central database by a banking institution and the program comprising: a recording medium readable by the computer; and the computer instructions stored on said recording medium instructing the computer to perform the processes including: reporting to the central database an evaluation report of the aggregation for soliciting investment; reporting to the central database a title certificate; reporting to the central database a licensing agreement report for the aggregation for licensing intellectual property assets to licensees; reporting to the central database a description of an intellectual property securitization fund for guaranteeing the intellectual property trust certificates; reporting to the central database a royalties receivable report for the aggregation; reporting to the central database an intellectual property securitization fund statement; reporting to the central database a surveillance report; reporting to the central database an intellectual property trust certificate chain of title report.

In another aspect, the computer assisted process for providing liquidity to an enterprise by utilizing intellectual property assets includes: a computer program storing computer instructions therein for instructing a computer to perform analytical steps for the centralized public sale of intellectual property trust certificates issuing from the securitization of intellectual property assets, the securitization initiated by an analytical entity and managed by a management company, the securities sold as intellectual property trust certificates to an investor having access to a central database by a banking institution and the program comprising: a recording medium readable by the computer; and the computer instructions stored on said recording medium instructing the computer to perform the processes including: identifying a focal market; aggregating intellectual property assets into an intellectual property asset aggregation relating to a focal market; reporting to the analytical entity a proposed structure for a management company for managing the securitization of intellectual property assets; validating the intellectual property assets of the intellectual property asset aggregation; reporting to the central database an evaluation report of the aggregation for soliciting investment; reporting to the central database a title certificate; reporting to the central database a licensing agreement report for the aggregation for licensing intellectual property assets to licensees; reporting a compendium report to a banking institution for determining a projected growth rate; receiving a projected growth rate from the banking institution; reporting to the banking institution a proposed capital structure for the intellectual property asset securitization and issuing of intellectual property trust certificates; receiving from the banking institution information regarding the issuing of intellectual property trust certificates; reporting to the analytical entity a description of an intellectual property securitization fund for guaranteeing the intellectual property trust certificates; reporting to a rating institution a pre-rating report for rating the intellectual property trust certificates; reporting to the central database a management company balance sheet; reporting to the central database a royalty receivable report; reporting to the central database an intellectual property security fund statement; reporting to the central database a surveillance report; receiving a bond rating from the rating institution; reporting to the banking institution a sales brochure for selling the intellectual property trust certificates; and reporting to the central database an intellectual property trust certificate chain of title report.

In yet another aspect, the computer assisted process for providing liquidity to an enterprise by utilizing intellectual property assets includes: a computer program storing computer instructions therein for instructing a computer to perform analytical steps for the centralized public sale of intellectual property trust certificates issuing from the securitization of intellectual property assets, the securitization initiated by an analytical entity and managed by a management company, the securities sold as intellectual property trust certificates to an investor having access to a central database by a banking institution and the program comprising: a recording medium readable by the computer; and the computer instructions stored on said recording medium instructing the computer to perform the processes including: identifying a focal market; aggregating intellectual property assets into an intellectual property asset aggregation relating to the focal market; reporting to the analytical entity a proposed structure for a management company for managing the securitization of intellectual property assets; validating the intellectual property assets of the intellectual property asset aggregation; reporting to the central database an evaluation report of the aggregation for soliciting investment; reporting to the central database a title certificate; reporting to the central database a licensing agreement report for the aggregation for licensing intellectual property assets to licensees; reporting a compendium report to a banking institution for determining a projected growth rate; receiving a projected growth rate from the banking institution; reporting to the banking institution a proposed capital structure, including a proposed tranching of the intellectual property assets into classes, for the intellectual property asset securitization and issuing of intellectual property trust certificates; receiving from the banking institution information regarding the issuing of intellectual property trust certificates and the tranching of those intellectual property trust certificates into classes; reporting to the analytical entity a description of an intellectual property securitization fund for guaranteeing the intellectual property trust certificates; reporting to a rating institution a pre-rating report for rating the intellectual property trust certificates; reporting to the central database a management company balance sheet; reporting to the central database a royalty receivable report; reporting to the central database an intellectual property security fund statement; reporting to the central database a surveillance report; receiving a bond rating from the rating institution; and reporting to the banking institution a sales brochure for selling the intellectual property trust certificates including the tranching of the intellectual property assets into classes; and reporting to the central database an intellectual property trust certificate chain of title report.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 shows the transactions involved in the securitization of intellectual property assets;

FIG. 2 shows the relationships between the entities of the Special Purpose Entity, the Rating and Banking Institutions and the Intellectual Property Trust Certificate Electronic Folder;

FIG. 3a is a flowchart showing steps involved in a computer program for assisting the centralized sale of intellectual property assets;

FIG. 3b is a continuation of the flowchart of FIG. 3a showing steps involved in a computer program for assisting the centralized sale of intellectual property assets;

FIG. 4a is a flowchart showing a computer program for assisting intellectual property asset securitization including centralized sale of intellectual property assets;

FIG. 4b is a continuation of the flowchart of FIG. 4a showing steps involved in another computer program for assisting intellectual property asset securitization including centralized sale of intellectual property assets;

FIG. 5a is a flowchart showing another computer program for assisting intellectual property asset securitization including centralized sale of intellectual property assets;

FIG. 5b is a continuation of the flowchart of FIG. 5a showing steps involved in another computer program for assisting intellectual property asset securitization including centralized sale of intellectual property assets;

FIG. 5c is a second continuation of the flowchart of FIG. 5a showing steps involved in another computer program for assisting intellectual property asset securitization including centralized sale of intellectual property assets;

FIG. 6a is a flowchart showing a computer program for assisting intellectual property asset securitization including centralized sale of intellectual property assets and including the tranching of the assets into classes;

FIG. 6b is a continuation of the flowchart of FIG. 4a showing steps involved in another computer program for assisting intellectual property asset securitization including centralized sale of intellectual property assets and the tranching of the assets into classes;

FIG. 7a is a flowchart showing another computer program for assisting intellectual property asset securitization including centralized sale of intellectual property assets and the tranching of the assets into classes;

FIG. 7b is a continuation of the flowchart of FIG. 7a showing steps involved in another computer program for assisting intellectual property asset securitization including centralized sale of intellectual property assets and the tranching of the assets into classes; and

FIG. 7c is a second continuation of the flowchart of FIG. 7a showing steps involved in another computer program for assisting intellectual property asset securitization including centralized sale of intellectual property assets and the tranching of the assets into classes.

### DETAILED DESCRIPTION OF THE PREFERRED EMBODIMENTS

Reference will now be made in detail to the preferred embodiments of the invention, examples of which are illustrated in the accompanying drawings. It will be apparent to those skilled in the art that various modifications and variations can be made in the embodiments of the invention, the computer assisted process for providing liquidity to an enterprise by utilizing intellectual property assets, without departing from the spirit or scope of the embodiments of the invention. Thus, it is intended that embodiments of the invention cover the modifications and variations of this invention provided within the scope of the appended claims and their equivalents. Like reference numerals in the drawings denote like elements.

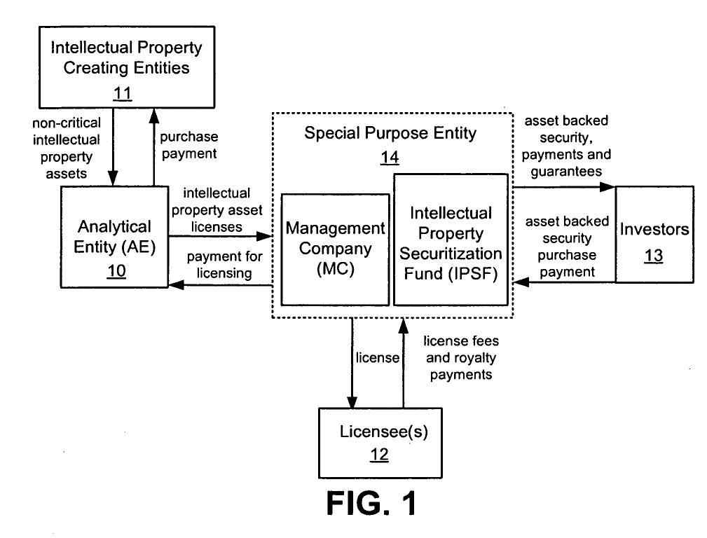

The computer assisted process of the embodiments of the invention interacts with several entities to provide liquidity to an enterprise by utilizing intellectual property assets. Prior to the discussion of the computer assisted process itself, each of the entities are discussed in some detail below. In the discussion, reference will be made to the components of an intellectual property mercerization shown in FIG. 1.

Intellectual property securitization is of value to the intellectual property holders for several reasons. First, intellectual property securitization can limit credit exposure and lower the cost of capital. Second, intellectual property securitization results in generally improved capital structure and ratings which lead to better leveraging of intellectual property assets. This better leveraging may even be used in the acquisition of additional intellectual property assets.

Investors in intellectual property securitization funds benefit in several ways. First, intellectual property-based securitization in the case of patents actually decouples technology risk from management and other operational risk. The decoupling comes from the fact that the investors are not investing directly in the technology firms themselves, which would entail taking on a measure of the firm's risk. Rather, the investors in intellectual property securitization are buying the cash flows derived from the licensing or selling of the technologies.

FIG. 1 shows the transactions involved in the securitization of intellectual property assets. The transaction involves an Analytical Entity 10, Patent Creating Company or Companies 11, Licensee or series of Licensees 12, and Investors 13 interacting with a Special Purpose Entity 14 that includes both a Management Company and Intellectual Property Securitization Fund. The Intellectual Property Creating Entity (or Entities) 11 is the company or companies that creates the intellectual property assets to be licensed and ultimately securitized. These companies may be, for example, technology firms. The intellectual property assets can be actual patents, copyrights and/or trademarks. Alternatively, the intellectual property assets can be licenses to patents, copyrights and/or trademarks. The intellectual property assets are either purchased in their entirety from the Intellectual Property Creating Entity (or Entities) 11 by the Analytical Entity 10 or are licensed. If licensing occurs, the Intellectual Property Creating Entity (or Entities) 11 generally only licenses intellectual property that is not critical to the operation of the Intellectual Property Creating Entity (or Entities) 11. Such non-critical intellectual property assets can include, for example, patents for technologies that are tangential to the principal or core technology of the Intellectual Property Creating Entity's largest income generating product. The Analytical Entity 10 aggregates the intellectual property assets obtained from the Intellectual Property Creating Entity (or Entities) 11 into an aggregation. Subsequently, the licenses for the aggregation are sold en masse to the Special Purpose Entity 14 for a purchase payment.

The Special Purpose Entity 14 is an entity that is formed to oversee the securitization of the intellectual property assets. The Special Purpose Entity 14 is bankruptcy-remote in the sense that the Special Purpose Entity 14 is not owned by the Analytical Entity 10 nor has any financial stake in either the Analytical Entity 10 or in the Intellectual Property Creating Entity (or Entities) 11. Keeping the Special Purpose Entity 14 bankruptcy-remote allows the Special Purpose Entity 14 to obtain a lower rate of interest from the Investors because of the inherent lowering of risk associated with keeping it bankruptcy-remote. The Special Purpose Entity 14 contains a Management Company that purchases the licenses for the intellectual property assets of the aggregation from the Analytical Entity 10 and directly oversees the securitization. The Special Purpose Entity 14 also contains an Intellectual Property Securitization Fund 5 that the Management uses to guarantee the securities with collateral. As shown in FIG. 1, the Special Purpose Entity 14 collects royalty streams and/or license fees from the Licensees.

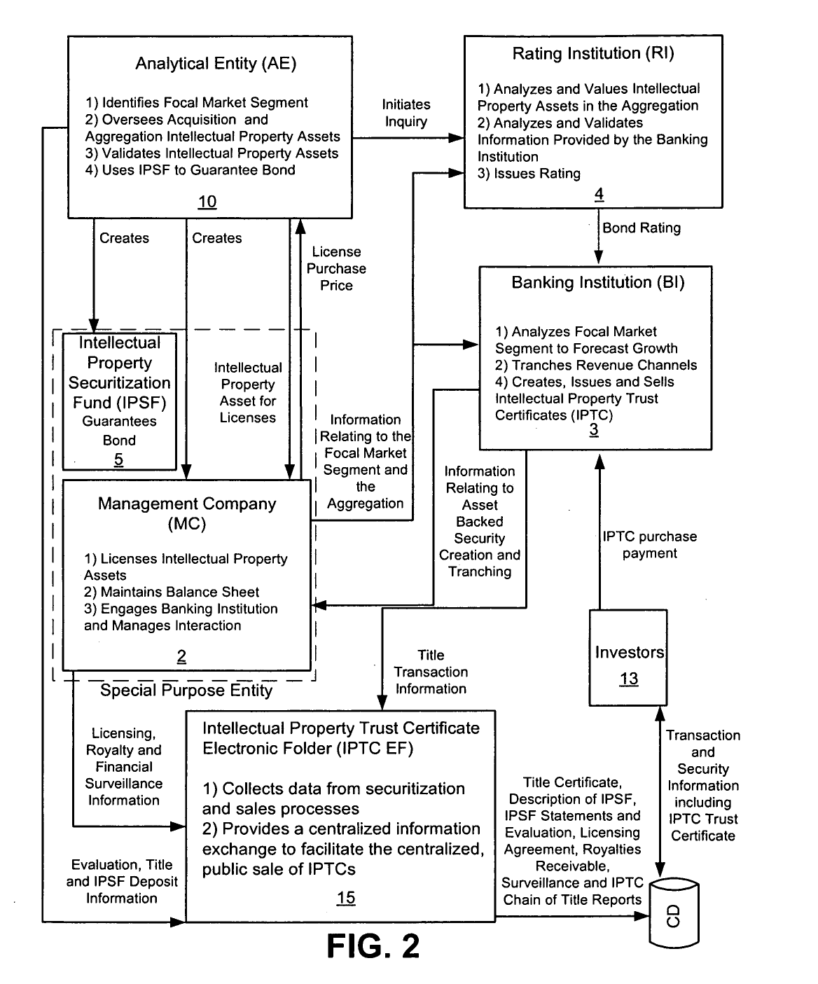

FIG. 2 shows the relationships between the entities of the Special Purpose Entity, the Rating and Banking Institutions and the Intellectual Property Trust Certificate Electronic Folder. In addition, the specific relationships between the Special Purpose Entity 14 and the Rating and Banking Institutions, in accordance with an embodiment of the invention, are also shown in FIG. 2.

The Intellectual Property Trust Certificate Electronic Folder (IPTC EF) 15 oversees the entire securitization process and the sale of the IPTCs and creates a central database CD to store information relevant to the entire process. The main purpose of the IPTC EF 15 is to interact with Investors 13 by providing updated information regarding the securitization and the intellectual property in the aggregation. The Investors 13 who interact with the IPTC EF 15 can be current investors holding titles to IPTCs or potential investors deciding whether to invest in IPTCs. By providing updated information, the activities of potential investors in IPTC can be coordinated and the acquisition of capital can be facilitated by enticing potential investors to invest in the securitization. Further, the IPTC EF 15 is accessible electronically, such as via the internet on a conventional web browser. The IPTC EF 15 serves to link Investors 13 who may be dispersed geographically to a centralized intellectual property investment exchange. The physical location of this exchange is irrelevant and can be geographically removed from the Investors 13.

The centralized database CD of the IPTC EF 15 stores the following items: the Title Certificate for the sale of the IPTCs to Investors 13, the description of the Intellectual Property Securitization Fund (IPSF) used to guarantee the IPTCs, IPSF statements that describe various deposits made to the IPSF, Evaluation Report for ascertaining the value of the intellectual property in the aggregation, Licensing Agreement Reports describing the licensing of the intellectual property in the aggregation to the Licensees 12, Royalties Receivable Reports describing the royalties obtained from the licensing of the intellectual property in the aggregation to the Licensees 12, Surveillance Reports that describe developments in the technology or financial markets relevant to intellectual property of the aggregation and IPTC chain of title reports describing sales and re-sales of the IPTCs to Investors 13.

As shown in FIG. 2 shows, the IPTC EF collects licensing, royalty and financial service information from the Management Company 2. The licensing information describes the agreements to license intellectual property to Licensees 12 to obtain royalties described by the royalty information and is used to create the Licensing Agreement Reports. The financial surveillance information describes changes in the technology and financial markets relevant to the intellectual property of the aggregation and are used by the IPTC EF to create the Surveillance Reports. The royalty information describes the royalty streams obtained from licensing the intellectual property to the Licensees 12 and is used by the IPTC EF to create the Royalties Receivable Report.

The Analytical Entity 10 identifies the focal market for intellectual property aggregation, identifies the intellectual property assets to be aggregated, ensures that intellectual property assets are valid and aggregates the intellectual property assets into the intellectual property aggregation. The Analytical Entity 10 can be a privately or publicly held. More particularly, the Analytical Entity 10 can identify a focal market based on its business objectives. The focal market for an Analytical Entity 10 that owns patents relating to DRAM technology, for example, would be semiconductor device technology. Similarly, an Analytical Entity 10 that purchases patents for aggregation can choose a focal market associated with the core technology associated with the purchased patents.

After the focal market has been identified, the Analytical Entity 10 compiles a list of intellectual property assets to be aggregated. Generally, these intellectual property assets will either be held directly by the Analytical Entity 10 or held indirectly through licensing. The Analytical Entity 10 can also acquire additional intellectual property assets in the aggregation, such as corporations owning such intellectual property assets or the licenses to such intellectual property assets. The intellectual property assets acquired belong to the focal market. The criterion for acquiring additional intellectual property assets depends on whether sufficient capital exists and on the results of a cost-benefit analysis to determine whether acquiring the additional intellectual property assets increases the overall value of the aggregation.

After compiling a list of the intellectual property assets, the Analytical Entity 10 either performs or commissions the performance of due diligence to “validate” the title or ownership of the intellectual property assets in the aggregation. Title or ownership of intellectual property assets can be directly related to the value of the intellectual property asset determining the ability to enforce the IP. Validation is accomplished with the help of intellectual property databases, legal professionals and/or qualified consulting firms. In the validation process, any invalid or possibly problematic intellectual property assets are removed from the aggregation.

After validating the intellectual property, the Analytical Entity 10 creates the Intellectual Property Securitization Fund 5 and uses the Intellectual Property Securitization Fund 5 to guarantee any asset backed securities issued as part of the securitization of intellectual property assets. Guaranteeing the asset backed securities provides a guarantee or assurance that the debt represented by the securitization bond will eventually be repaid. The Analytical Entity 10 can further lower the credit risk of the asset backed securities by requiring collateral, insurance or other agreements for the investors.

The Management Company oversees the securitization process, including the selling of asset backed securities to investors and the licensing of the intellectual property assets from the Analytical Entity 10 to the licensees. The Management Company purchases licenses from the Analytical Entity 10 for all of the intellectual property assets in the aggregation so as to be able to sell the licenses to the Licensees, as shown in FIG. 1, for royalties. Further, the Management Company maintains a balance sheet listing all records of the revenue and expenses of the Management Company, Intellectual Property Securitization Fund 5 and the Analytical Entity 10. The balance sheet details the assets, liabilities as well as the equity held by the Investors. Furthermore, the Management Company engages the Banking Institution 3 by providing the Banking Institution 3 with information regarding the focal market as well as the intellectual property asset aggregation. In addition, the Management Company can provide a proposed capital structure, including tranching of assets, for the intellectual property asset aggregation.

The Banking Institution 3 can be a bank or an investment bank. The Banking Institution 3 can also be a public authority, credit institution, company or other supranational institution in the primary markets. The Banking Institution 3 is commissioned by the Management Company to oversee the mechanics of the securitization process. When the Management Company supplies the Banking Institution 3 with all relevant information, including the intellectual property asset aggregation, focal market and a proposed capital structure for the securitization, the securitization process is engaged. During the securitization process, the Banking Institution 3 performs an analysis for determining the market share as well as growth and revenue forecasts for the Analytical Entity 10. This analysis is performed with standard tools for forecasting growth, market share and revenues may be used by the investment bank. The results of the analysis are then used to forecast the growth rate of the intellectual property asset aggregation of the Analytical Entity 10 to determine an investment recommendation.

If the Banking Institution 3 finds tranching to be acceptable, the Banking Institution 3 will implement the capital structure proposed by the Management Company. This can include tranching of the intellectual property asset aggregation. Asset-backed security tranching refers to partitioning the securities into classes based on their maturity. Tranched assets are priced and sold to investors based on their specific needs. For example, a tranche that includes intellectual property assets yielding relatively high short-term cash flows can be sold at a relatively low interest rate to investors with immediate cash flow needs. On the other hand, a tranche that includes intellectual property assets yielding cash flows that are relatively low in the short-term may be sold at a higher interest rate to investors with more long-term needs. Tranching improves the marketability of assets by allowing access to a more diverse pool of investors.

The asset backed securities are debt securities that typically oblige the Management Company to periodic payments of interest as well as to repay the debt when the bond reaches maturity. Although the asset backed securities usually reach maturity in term that is longer than a year, the asset backed securities can also reach maturity in a period that is less than one year. In addition to these stipulations, there can be other stipulations in the intellectual property asset backed security transaction. These other stipulations can include an information requirement requiring the Management Company to provide information or periodic updates to the Investor regarding the status of the intellectual property asset aggregation. These other stipulations can also include limitations on the behavior of the Management Company, such as limitations on the sales of assets.

The Banking Institution 3 creates asset backed securities as intellectual property asset backed securities. Asset backed securities are issued, underwritten and sold by the Banking Institution 3. Specifically, the Banking Institution 3 buys an entire issue of asset backed securities from the Management Company and re-sells the asset backed securities to Investors.

The Rating Institution 4 analyzes the intellectual property asset aggregation so as to provide the Banking Institution 3 With a rating for the intellectual property asset aggregation. The Rating Intuition values the intellectual property assets in the aggregation by performing one of a number of analyses which can be either quantitative or qualitative. The Rating Institution then issues a rating of the intellectual property asset aggregation based on the analysis and valuation.

Qualitative valuation methods include dividing the intellectual property assets into classes based on their exploitation value. For example: “monopoly class” patents are patents having high internal exploitation value, “defensive class” patents tare patents having relatively low internal exploitation value, “license class” patents are patents having high external exploitation value, and “joint venture class” patents are patents having relatively low external exploitation value.

Additional qualitative valuation methods include those that weigh factors like an evaluation of rights, transferability and business potential. An evaluation of rights evaluates the status and relative strength of enforcement rights associated with each patent as well as the expiration of the patent. Other characteristics, such as the technology associated with the intellectual property asset or any pending disputes with third parties, can also be considered either qualitatively or quantitatively. Examples of issues considered in an evaluation of the transferability include: the need for additional development for commercialization, technical support required, licensing constraints, and the obligation or cooperation of owner in response to infringement.

The Rating Institution can also perform a quantitative valuation. In the quantitative valuation bond credits and issue options can be analyzed. The quantitative valuation can also contain an analysis and numerical rating of the entire focal market, focal market industry growth rates, special risks associated with the focal market and the stability of the leading companies competing in the focal market. The quantitative valuation can also contain an analysis and numerical rating of the bond issuing company's position in its industry, the viability of any new products associated with the intellectual property assets of the aggregation, the outlook for growth in revenues and cash flow for the Analytical Entity 10. The quantitative valuation can also contain an analysis and numerical rating of any special provisions in the bond indenture, any bond-related covenants protecting the bondholder, any use of the money raised in bond offerings, any debt seniority, any secondary market liquidity and any call provisions.

The Rating Intuition determines the relative accuracy of the growth rate forecast and market share information provided by the Banking Institution 3. Further, the Rating Institution examines the capital structure of the securitization and determines if other tranching methodology can be employed to further minimize risk, maximize reward and maturities on the intellectual property based assets in the aggregation.

The Intellectual Property Securitization Fund 5 is used by the Analytical Entity 10 to guarantee percentage of asset backed securities created by the Banking Institution 3 during the securitization. The percentage of the bond that is guaranteed can be calculated as a function of the balance sheet. Alternatively, the percentage of the bond that is guaranteed can be a predetermined worth of the intellectual property backed asset.

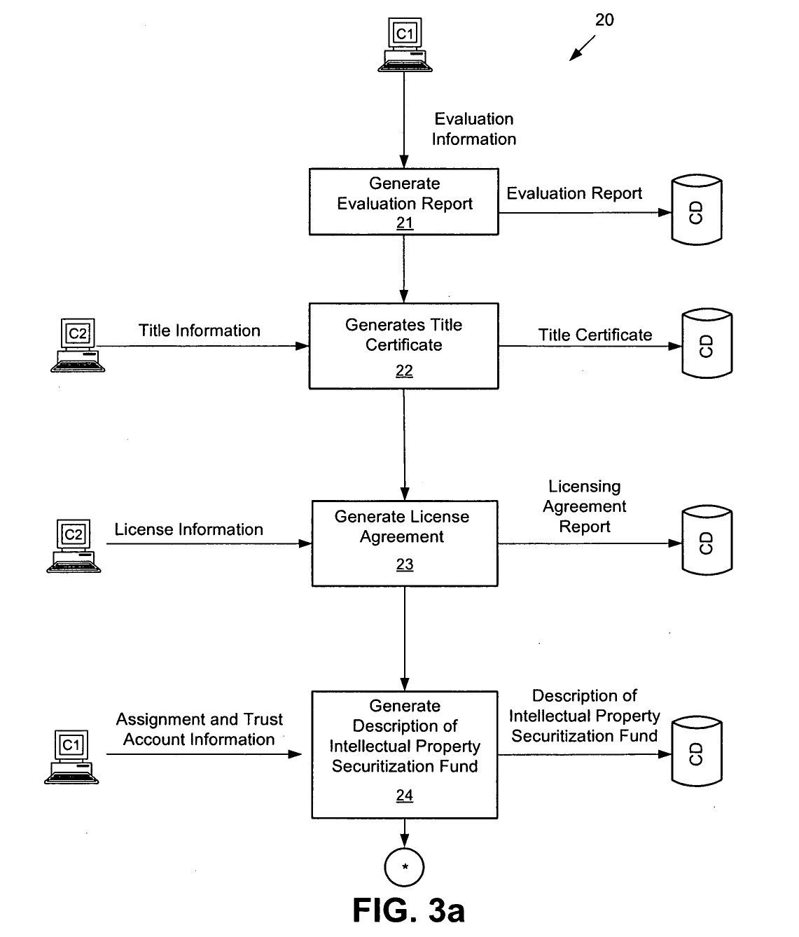

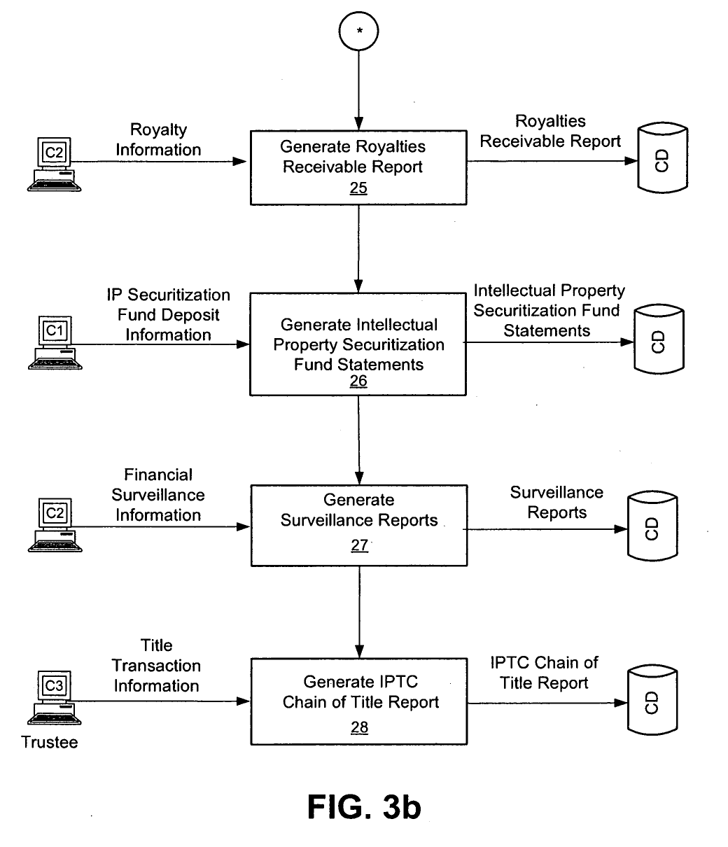

FIGS. 3a-3b together make up a single flowchart showing the computer program for assisting for intellectual property asset securitization in an embodiment of the invention. FIG. 3a is the beginning of the operation of the program to intermediate point * while FIG. 3b shows the continuation of the program from intermediate point * to the stopping point.

The computer program 20 receives Evaluation Information from the Analytical Entity C1 and generates and writes to the central database CD an Evaluation Report, as shown in FIG. 3a in the Generate Evaluation Report 21 step. Next, the program 20 receives Title Information from the Management Company C2 and generates and writes to the central database CD a Title Certificate, as shown in FIG. 3a in the Generate Title Certificate 22 step. Subsequently, the program 20 receives License Information from the Management Company C2 and generates and writes to the central database CD a Licensing Agreement Report, as shown in FIG. 3a in the Generate Licensing Agreement 23 step. Next, the computer program 20 receives Assignment and Trust Account Information from the Analytical Entity C1 and generates and writes to the central database CD a Description of Intellectual Property Securitization Fund, as shown in FIG. 3a in the Generate Description of Intellectual Property Securitization Fund 24 step. Subsequently, the program 20 receives Royalty Information from the Management Company C2 and generates and writes to the central database CD a Royalties Receivable Report, as shown in FIG. 3b in the Generate Royalties Receivable Report 25 step. Next, the computer program 20 receives IP. Securitization Fund Deposit Information from the Analytical Entity C1 and generates and writes to the central database CD IP Securitization Fund Statements, as shown in FIG. 3b in the Generate IP Securitization Fund Statements 26 step. Subsequently, the program 20 receives Financial Surveillance Information from the Management Company C2 and generates and writes to the central database CD Surveillance Reports, as shown in FIG. 3b in the Generate Surveillance Reports 27 step. The program 20 then receives Title Transaction Information from the Banking Institution C3 and generates and writes to the central database CD an IPTC Chain of Title Report, as shown in FIG. 3b in the Generate Chain of Title Report 28 step.

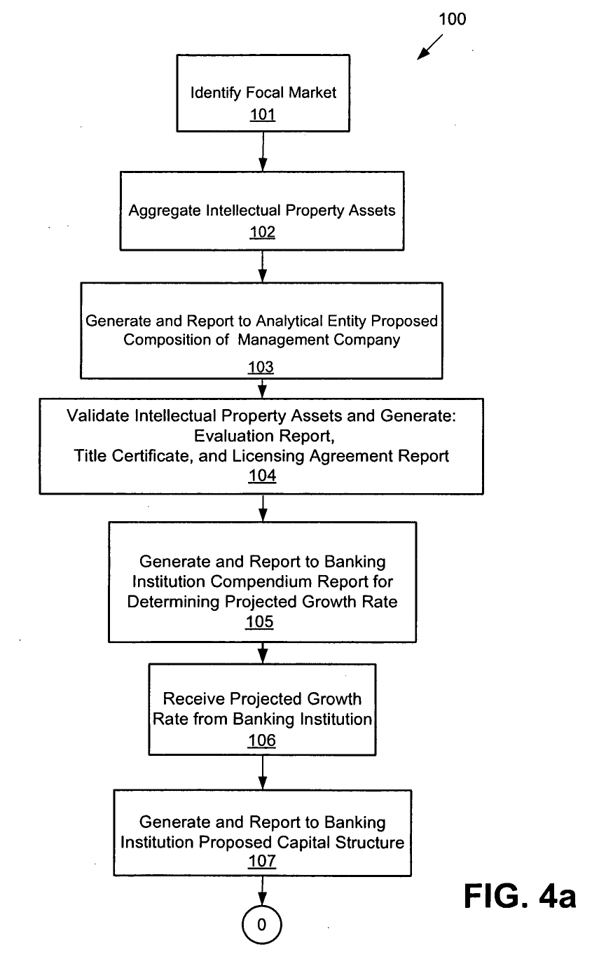

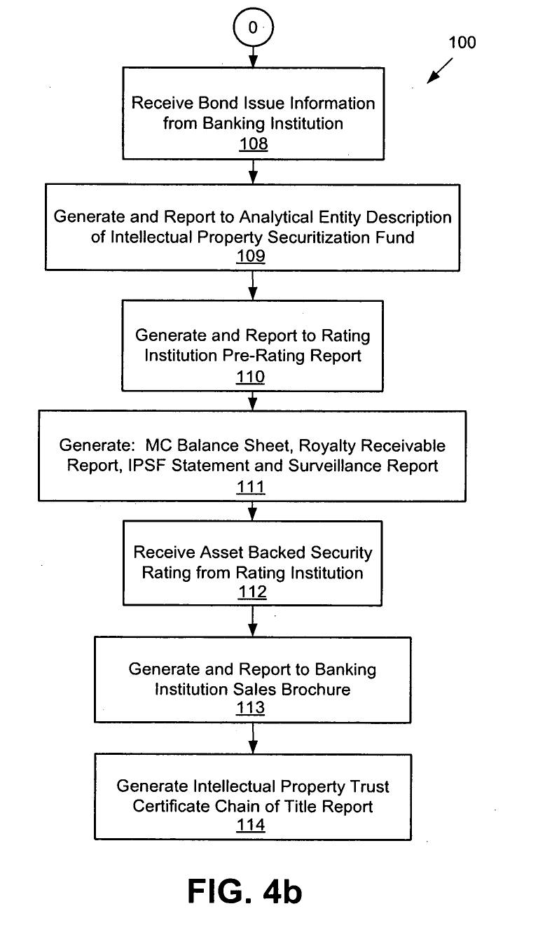

FIGS. 4a-4b together make up a single flowchart showing the computer program for assisting for intellectual property asset securitization in an embodiment of the invention. FIG. 4a is the beginning of the operation of the program to intermediate point 0 while FIG. 4b shows the continuation of the program from intermediate point 0 to the stopping point.

The computer program 100 is used to identify the focal market for the intellectual property asset aggregation as shown in the Identify Focal Market 101 step. Next, the program 100 selects intellectual property assets relating to the focal market, aggregates the intellectual property assets relating to the focal market into an intellectual property asset aggregation, as shown in the Aggregate Intellectual Property Assets 102 step. Subsequently, the program 100 generates and reports to the Analytical Entity 10 the intellectual property asset aggregation as well as a proposed structure for a Management Company for managing the securitization of intellectual property assets in the aggregation, as shown in the Generate and Report to the Analytical Entity Proposed Composition of Management Company 103 step. The program 100 then submits the intellectual property assets in the aggregation for ownership validation, as shown in the Validate intellectual property Assets 104 step. During the Validate intellectual property Assets 104 step, the program 100 removes invalid intellectual property assets from the aggregation. The program 100 also generates an Evaluation Report for the aggregation, a title certificate for the IPTCs sold to Investors 13 and a Licensing Agreement Report describing the licenses of the intellectual property to the Licensees 12. The program writes these reports to the central database CD (not shown) where they can be accessed by Investors 13. Subsequently, the program 100 generates and reports to the Banking Institution 3 a compendium report that includes information relevant to the determination of a projected growth rate for the aggregation, as shown in the Generate and Report to Banking Institution Compendium Report for Determining Projected Growth Rate 105 step.

The program 100 then receives, either as direct user input or by file transfer, from the Banking Institution 3 a projected growth rate for the aggregation generated by the Banking Institution 3 using the compendium report, as shown in the Receive Projected Growth Rate from Banking Institution 106 step. Next, the program 100 uses information regarding the intellectual property asset aggregation and the projected growth rate to generate a proposed capital structure for the securitization and reports the proposed capitalization structure to the Banking Institution 3, as shown in the Generate and Report to Banking Institution Proposed Capital Structure 107 step. Subsequent to receiving the proposed capital structure from the program 100, the Banking Institution 3, decides whether to implement the proposed capital structure, then creates and issues asset backed securities backed by the intellectual property asset aggregation. The program 100 then receives, either as direct user input or by file transfer, from the Banking Institution 3 information relating to the bond issue as shown in the Receive Bond Issue Information from Banking Institution 108 step. Using the bond issue information, the program 100 generates and reports to the Analytical Entity 10 a description of the intellectual property securitization fund to be used to guarantee the asset backed securities, as shown in the Generate and Report to Analytical Entity Description of Intellectual Property Securitization Fund 109 step.

Using the bond issue information, the program 100 then generates a pre-rating report and sends the pre-rating report to the Rating Institution 4, as shown in the Generate and Report to Rating Institution Pre-Rating Report 110 step. The pre-rating report contains all the results of the validity analysis, the focal market data, the capital structure of the securitization, the bond issue information as well as the results of any other analysis performed by the Banking Institution 3. Next, the program 100 generates and writes to the central database CD an MC Balance Sheet, Royalty Receivable Report, IPSF Statement and Surveillance Report in the Generate MC Balance Sheet, Royalty Receivable Report, IPSF Statement and Surveillance Report Step 111. The program 100 then receives, either as direct user input or by file transfer, from the Rating Institution 4 a rating for the asset backed securities generated using the information to valuate the asset backed securities, as shown in the Receive Bond Rating from the Rating Institution 112 step. The program 100 then generates and reports to the Banking Institution 3 a sales brochure for the sale of the asset backed securities that includes the rating from the rating institution along with the compendium report, as shown in the Generate and Report to Banking Institution Sales Brochure 113 step. The Banking Institution 3 then sells the asset backed securities to investors using the sales brochure. Finally, the program 100 generates an Intellectual Property Trust Certificate Chain of Title Report and writes it to the central database CD in the Generate Intellectual Property Trust Certificate Chain of Title Report 114 step.

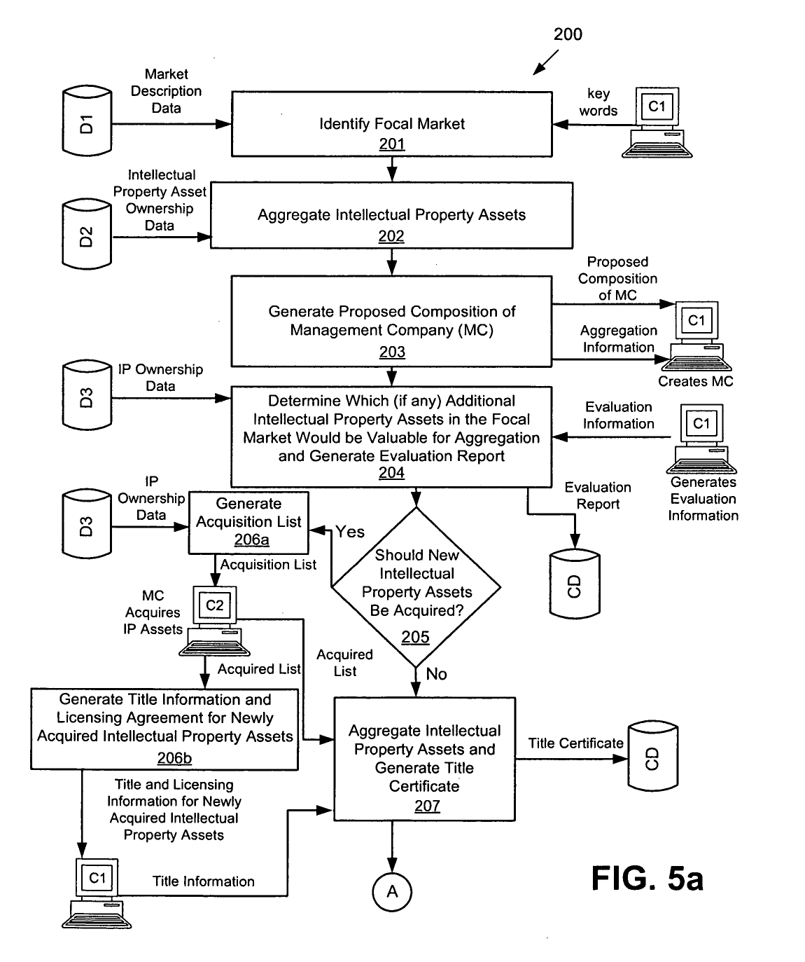

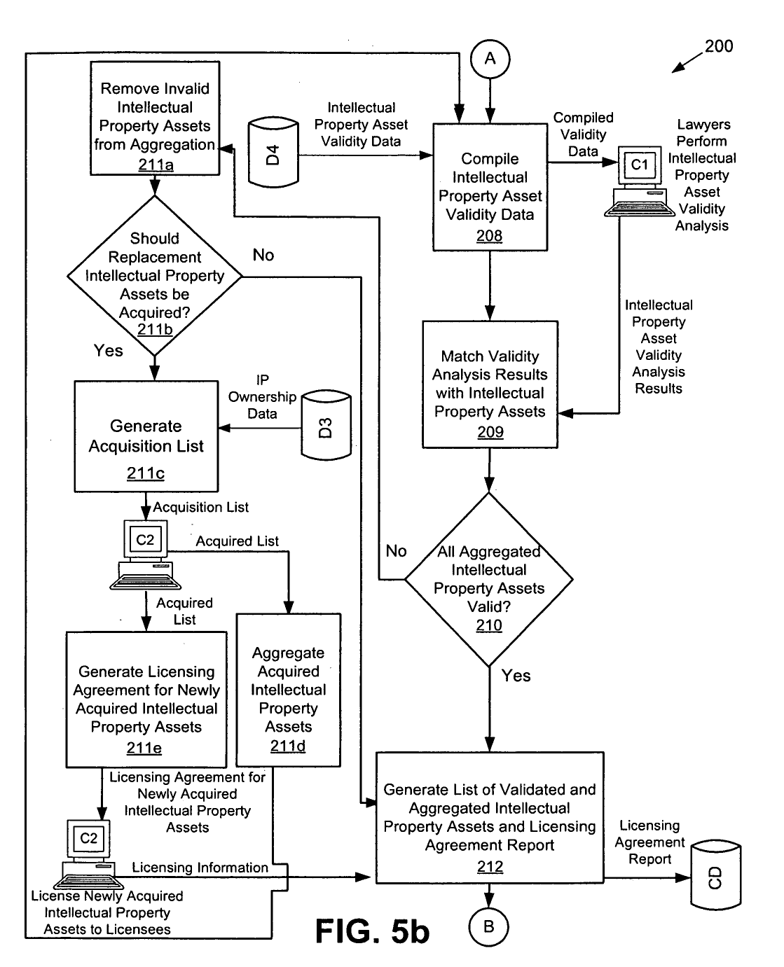

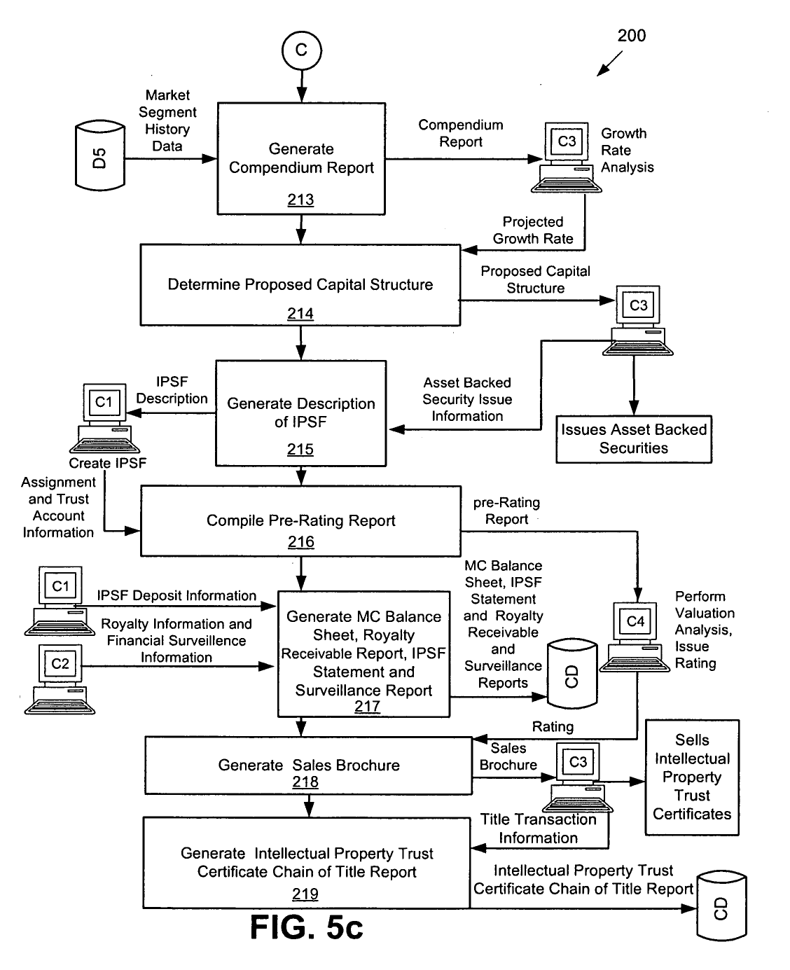

FIGS. 5a-5c together make up a single flowchart showing another computer program for assisting intellectual property asset securitization in an embodiment of the invention. FIG. 5a is the beginning of the operation of the program to intermediate point A, FIG. 5b shows the continuation of the program between intermediate points A and B and FIG. 5c shows the continuation of the program from intermediate points B to the stopping point.

The program 200 begins by identifying the focal market for the intellectual property asset aggregation, as shown in the Identify Focal Market 201 step. As shown in the Identify Focal Market 201 step of FIG. 5a, the program 200 receives, either as direct user input or by file transfer, key words from the Analytical Entity C1. The key words describe the business objectives Analytical Entity C1, the technology or industry of the intellectual property assets held by the Analytical Entity C1 or those to be acquired by the Analytical Entity C1. The program 200 then accesses a market segment database D1 that contains focal markets indexed by focal market descriptors and matches the key words to the focal market descriptors of the market segment database to identify a focal market for aggregating intellectual property assets into an intellectual property asset aggregation. Examples of focal markets include semiconductor technology if the Analytical Entity C1 holds intellectual property assets in DRAM technology, biomedical device technology if the Analytical Entity C1 holds intellectual property assets in medical diagnostic or implant devices, or alternative energy technology if the Analytical Entity C1 holds intellectual property assets in ethanol fuel production technologies or solar cell device technologies.

Next, the program 200 selects intellectual property assets relating to the focal market and aggregates them into an the intellectual property asset aggregation, as shown in the Aggregate Intellectual Property Assets 202 step. As shown in FIG. 5a, the program 200 accesses an intellectual property asset ownership database D2 of intellectual property assets held by the analytical entity and indexed by focal market descriptors, matching the key words to the focal market descriptors of the intellectual property asset ownership database so as to generate a list of intellectual property assets held by the Analytical Entity C1 for aggregation.

The program 200 then generates and reports to the Analytical Entity C1 the intellectual property asset aggregation and a proposed structure for a Management Company for managing the securitization of intellectual property assets in the aggregation, as shown in the Generate Proposed Composition of Management Company (MC) 203 step. The proposed structure of the Management Company specifies the locale, board membership and recommended financial holdings of the company. The program 200 determines the structure of the Management Company using algorithm or algorithms that access a database (not shown) of information including unaffiliated and eligible professionals capable of serving on the board, potential financial holdings and advantageous locations for the location of the Management Company. After receiving the proposed structure of the Management Company from the program 200, the Analytical Entity C1 creates Management Company.

The program 200 subsequently determines if additional intellectual property assets should be added to the aggregation, as shown in the Determine Which (if any) Additional Intellectual Property Assets in the Focal Market Would be Valuable for Aggregation and Generate Evaluation Report 204 step. As shown in FIG. 5a, the program 200 accesses an intellectual property asset ownership database of intellectual property assets D3 held by a plurality of companies, not including the analytical entity, indexed by focal market descriptors. The program 200 then matches the key words describing the business objectives of Analytical Entity C 1 to the focal market descriptors of the market segment database so as to determine whether new intellectual property assets should be acquired and aggregated. The program 200 also receives Evaluation Information from the Analytical Entity C1 and generates an Evaluation Report for the aggregation and writes it to the central database CD. As shown in FIG. 5a, the program 200 determines whether new intellectual property assets should be acquired for the aggregation, in the Should New Assets Be Acquired 205 step.

As shown in FIG. 5a, the program 200 proceeds to the Generate Acquisition List 206a step if new assets are to be acquired. To generate the acquisition list, the program 200 accesses the intellectual property asset ownership database of intellectual property assets D3 held by a plurality of companies, not including the analytical entity, indexed by focal market descriptors and generates the Acquisition List of intellectual property assets to be acquired. The program 200 then reports the Acquisition List to the Management Company C2 which acquires the assets. Subsequently, the program 200 generates and reports to the Analytical Entity C1 a license agreement for the intellectual property assets on the list of acquired replacement intellectual property assets, as shown in the Generate Licensing Agreement for Newly Acquired Intellectual Property Assets 206b step. The program 200 then receives, either as direct user input or by file transfer, the Acquired List of acquired intellectual property assets from the Management Company C2, as shown in the Aggregate Intellectual Property Assets 207 step. The program 200 then aggregates all intellectual property to be aggregated, as shown in the Aggregate Intellectual Property Assets and Generate Title Certificate and Generate Title Certificate 207 step. The program also receives Title Information from the Analytical Entity C1 and generates the Title Certificate and writes the generated Title Certificate to the central database CD (not shown) for Investor 13 access. Subsequently, the program 200 submits the intellectual property assets in the aggregation for ownership validation, as shown in the Compile Intellectual Property Asset Validity Data 208 step in FIG. 5b. The program 200 compiles validity data pertaining to the ownership of all intellectual property in the aggregation. The validity data can include any information relevant to the ownership and license of the intellectual property in the aggregation, such as titles, licensing agreements or relevant litigation or contracts. The program 200 reports to the Analytical Entity C1 the validity data so that a legal analysis of the validity of intellectual property assets in the aggregation can be performed by either the Analytical Entity C1 itself or by lawyers or other intellectual property professionals commissioned by the Analytical Entity C1.

The Analytical Entity C1 performs the validation analysis by using in-house legal counsel. Alternatively, the Analytical Entity C1 can perform the validation analysis by commissioning a law firm, a consulting firm or other entity external to the Analytical Entity C1 and staffed with legal professionals with intellectual property specializations. In the validity analysis, the legal professionals examine the legal documents pertaining to both licensing and ownership of the intellectual property assets, the usefulness of the intellectual property assets for litigation and the time remaining until expiration of the intellectual property assets. In the validity analysis, the legal professions determine whether relevant licensing agreements are proper. This includes reviewing the documents for any errors or omissions, ensuring that each has been properly signed and filed and that proper approval for all relevant documents has been received. In the validity analysis, the legal professions also determine any outstanding issues not included explicitly in the licensing or ownership documents themselves that may also affect the validity of the intellectual property. Examples of outstanding issues that are examined by the legal professionals include any incomplete documentation, evidence that rightful inventors, authors or artists have been disincluded in the intellectual property ownership and any pending patent interference proceedings or litigation. In the validity analysis, the legal professions investigate these and other factors that can prevent the use of the intellectual property assets in litigation or the further sale or licensing of the intellectual property assets.

In the cases in which the intellectual property assets of the aggregation include patents with complex patent prosecution histories, the rightful ownership, inventorship and length of time until expiration of the intellectual property is investigated on a claim-by-claim basis. Inventorship of each claim is established individually to determine if licensing agreements and or sale of the portions of the patent that pertain to the claim are legally sound. Further, the term of each claim is established and rated against the claim's inherent usefulness for litigation purposes in the focal market of the aggregation. For patents, the legal professionals can also employ technical professionals including scientists, engineers and patent search professionals to survey both prior art relevant to the invention and as patents for similar technologies that have potentially overlapping claims.

Once the legal analysis is performed, the program 200 receives, either as direct user input or by file transfer, the validity analysis results from the Analytical Entity C1 and matches the validity analysis results with the intellectual property assets in the aggregation, as shown in the Match Validity Analysis Results with Intellectual Property Assets 209 step.

Next, the program 200 identifies any invalid intellectual property assets in the aggregation, as shown in the All Aggregated Intellectual Property Assets Valid 210 step. If invalid assets are found, the program 200 removes the invalid assets from the aggregation, as shown in the Remove Invalid Intellectual Property Assets From 211a step in FIG. 5b. Next, the program 200 determines whether the removed intellectual property assets is to be replaced, as shown in the Should Replacement Intellectual Property Assets be Acquired 211b step. Invalid assets are replaced if they made up a large portion of the assets in the aggregation or if the values of the invalid assets are particularly high relative to the average value of the intellectual property assets in the aggregation.

If the assets are to be replaced, the program 200 generates an Acquisition List of replacement intellectual property assets to be acquired, as shown in the Generate Acquisition List 211c step. As shown in FIG. 5b, the program 200 matches the key words describing the business objectives of the Analytical Entity C1 to the focal market descriptors of the intellectual property asset ownership database D3 so as to determine the Acquisition List and reports the Acquisition List to the Management Company C2. Subsequently, the program 200 receives, either as direct user input or by file transfer, an Acquired List of acquired replacement intellectual property assets from the Management Company C2, as shown in the Aggregate Acquired Intellectual Property Assets 211d step. Simultaneously, the program 200 generates and reports to the Analytical Entity C1 a license agreement for the intellectual property assets on the list of acquired replacement intellectual property assets, as shown in the Generate Licensing Agreement for Newly Acquired Intellectual Property Assets 211e step. The program 200 then re-initiates the validation process for the intellectual property asset aggregation, as shown in FIG. 5b by the arrow connecting the Aggregate Acquired Intellectual Property Assets 211d step with the Compile Intellectual Property Asset Validity Data 208 step. The validation process is re-imitated so that all newly acquired intellectual property assets are validated.

The program 200 then receives Licensing Information from the Management Company C2 and generates a Licensing Agreement Report and then generates a list of validated and aggregated intellectual property assets, as shown in the Generate List of Validated and Aggregated Intellectual Property Assets and Licensing Agreement Report 212 step. Subsequently, the program 200 generates a compendium report describing the intellectual property assets in the aggregation, as shown in FIG. 5c in the Generate Compendium Report 213 step. As shown in FIG. 5c, generating the compendium report includes accessing a market segment history database D5 containing information relating to the growth rate, market share held by the Analytical Entity C1 and revenue history of the focal market. The data from the validity analysis results, a summary of the growth rate history of the intellectual property assets held by the intellectual property asset Analytical Entity C1, a summary of the market share history held by the Analytical Entity C1, and a summary of the history of the focal market sector are all included in the compendium report sent by the program 200 to the Banking Institution C3 for determining a projected growth rate for the intellectual property asset aggregation, as shown in FIG. 5c.

Next, the program 200 receives, either as direct user input or by file transfer, from the Banking Institution C3 the projected growth rate for the aggregation, as shown in the Determine Proposed Capital Structure 214 step. The program 200 uses information regarding the intellectual property asset aggregation and the projected growth rate to generate a proposed capital structure for the securitization and reporting the proposed capital structure for the securitization of the aggregated intellectual property assets to the Banking Institution C3 for securitizing the aggregated intellectual property assets and issuing asset backed securities for the intellectual property asset securitization. Subsequently, the program 200 reports the proposed capital structure to the Banking Institution C3. Then, the Banking Institution C3 decides whether to implement the proposed capital structure and creates and issues asset backed securities backed by the intellectual property asset aggregation. The program 200 then receives, either as direct user input or by file transfer, information relating to the bond issue from the Banking Institution C3. The program 200 then uses the bond issue information to generate and report to the Analytical Entity a description of the Intellectual Property Securitization Fund 5 to be used to guarantee the asset backed securities, as shown in the Generate Description of IPSF 215 step. As shown in FIG. 5c, the Analytical Entity uses the description of the Intellectual Property Securitization Fund to create the Intellectual Property Securitization Fund.

The program 200 then uses the bond issue information to generate and send to the Rating Institution C4 a pre-rating report, as shown in the Compile Pre-Rating Report 216 step. The pre-rating report consists of the compendium report, projected growth rate and bond issue information. This report can contain all the results of the validity analysis, the focal market data, the capital structure of the securitization, the bond issue information as well as the results of any other analysis performed by the Banking Institution C3. As shown in FIG. 5c, the program 200 then reports the pre-rating report to a Rating Institution C4 that uses the pre-rating report to rate the asset backed securities for the intellectual property asset securitization. Subsequently, the program 200 receives IPSF Deposit Information from the Analytical Entity C1, receives Royalty Information and Financial Surveillance Information from the Management Company C2 and generates and writes to the central database CD a balance sheet for the Management Company, a Royalty Receivable Report, an IPSF Statement and a Surveillance Report as shown in the Generate MC Balance Sheet, Royalty Receivable Report, IPSF Statement and Surveillance Report 217 step.

As shown in FIG. 5c, the Rating Institution C4 uses the information in the pre-rating report to valuate the asset backed securities and issue a rating. The program 200 then receives, either as direct user input or by file transfer, the rating from the Rating Institution C4. The program 200 then generates and reports to the Banking Institution C3 a sales brochure for the selling of the asset backed securities that includes the rating from the rating institution along with the compendium report, as shown in the Generate Sales Brochure 218 step. The sales brochure includes: the balance sheet for the Management Company generated in step 217, a description of the Intellectual Property Securitization Fund 5, securitization balance sheet, rating and projected growth rate. As shown in FIG. 5c, the Banking Institution C3 then sells the asset backed securities to investors using the sales brochure. Subsequently, as shown in FIG. 5c, the program 200 receives Title Transaction Information from the Banking Institution C3 and generates and writes to the central database CD a Intellectual Property. Trust Certificate Chain of Title Report as shown in the Generate Intellectual Property Trust. Certificate Chain of Title Report 219 step.

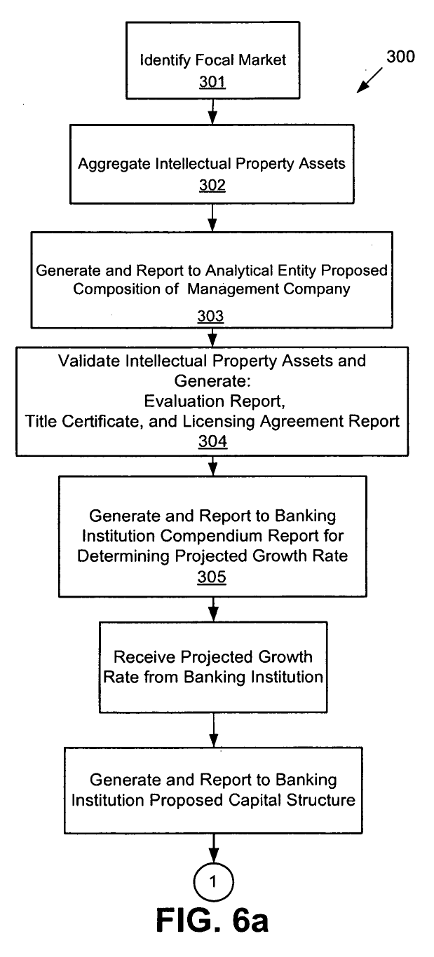

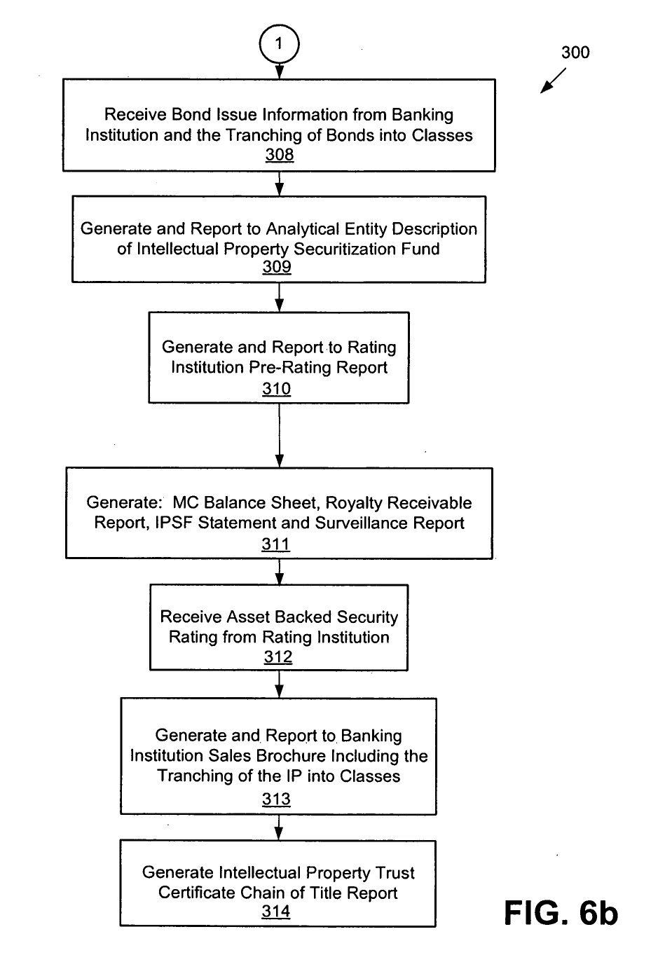

FIGS. 6a-6b together make up a single flowchart showing the computer program for assisting intellectual property asset securitization in another embodiment of the invention. FIG. 6a is the beginning of the operation of the program to intermediate point 1 while FIG. 6b shows the continuation of the program from intermediate point 1 to the stopping point.

The computer program 300 is used to identify the focal market for the intellectual property asset aggregation as shown in the Identify Focal Market 301 step. Next, the program 300 selects intellectual property assets relating to the focal market, aggregates the intellectual property assets relating to the focal market into an intellectual property asset aggregation, as shown in the Aggregate Intellectual Property Assets 302 step. Subsequently, the program 300 generates and reports to the Analytical Entity 10 the intellectual property asset aggregation as well as a proposed structure for a Management Company for managing the securitization of intellectual property assets in the aggregation, as shown in the Generate and Report to the Analytical Entity Proposed Composition of Management Company 303 step. The program 300 then submits the intellectual property assets in the aggregation for ownership validation, as shown in the Validate intellectual property Assets 304 step. During the Validate intellectual property Assets 304 step, the program 300 removes invalid intellectual property assets from the aggregation. The program 300 also generates an Evaluation Report for the aggregation, a title certificate for the IPTCs sold to Investors 13 and a Licensing Agreement Report describing the licenses of the intellectual property to the Licensees 12. The program writes these reports to the central database CD (not shown) where they can be accessed by Investors 13. Subsequently, the program 300 generates and reports to the Banking Institution 3 a compendium report that includes information relevant to the determination of a projected growth rate for the aggregation, as shown in the Generate and Report to Banking Institution Compendium Report for Determining Projected Growth Rate 305 step.

The program 300 then receives, either as direct user input or by file transfer, from the Banking Institution 3 a projected growth rate for the aggregation generated by the Banking Institution 3 using the compendium report, as shown in the Receive Projected Growth Rate from Banking Institution 106 step. Next, the program 300 uses information regarding the intellectual property asset aggregation and the projected growth rate to generate a proposed capital structure for the securitization and reports the proposed capitalization structure to the Banking Institution 3, as shown in the Generate and Report to Banking Institution Proposed Capital Structure Including a Proposed Tranching of the IP into Classes 307 step.

The program 300 determines proposed the tranching of the intellectual property assets into classes is based on their maturity. The program 300 first determines the number of classes and the payment timing for those classes, where the payment timing is the timing of payments to the investor. The tranching will be such that certain classes will pay cash flows to investors in the short term, while other classes will pay greater cash flows to the investors in the long term. The program 300 determines the payment timing by analyzing data from similar asset securitizations. For example, the program 300 can propose tranching the intellectual property assets of the aggregation into classes that are identical to those used in one recent intellectual property asset securitization. Alternatively, the program 300 can propose to tranch the intellectual property assets of the aggregation into classes based on averages of payment timing schemes for a number of recent intellectual property asset securitizations. The program 300 then determines the pricing for each tranch, generally inversely related to the timing of payments, by first analyzing the pricing data from similar securitizations and then interpolating between those data to find appropriate pricing to match the payment timing. For example, the program 300 can determine the price of each tranch by matching payment timing to tranches in one recent intellectual property asset securitization. Alternatively, the program 300 can determine the price of each tranch by averaging prices for tranches matching the payment timing of the tranch one recent intellectual property asset securitization, by tranching the intellectual property assets of the intellectual property asset aggregation into classes based on averages of payment timing schemes for a number of recent intellectual property asset securitization.

Subsequent to receiving the proposed capital structure, including the tranching of the intellectual property assets into classes, from the program 300, the Banking Institution 3, decides whether to implement the proposed capital structure, then creates and issues asset backed securities backed by the intellectual property asset aggregation. The Banking Institution 3 can decide to utilize the tranching classes proposed by the program 300, or develop another tranching scheme. If the Banking Institution 3 develops another tranching scheme, the tranching scheme developed by the Banking Institution 3 can be based on the tranching scheme proposed by the program 300.

The program 300 then receives, either as direct user input or by file transfer, from the Banking Institution 3 information relating to the bond issue as shown in the Receive Bond Issue Information from Banking Institution 308 step. Using the bond issue information, the program 300 generates and reports to the Analytical Entity 10 a description of the intellectual property securitization fund to be used to guarantee the asset backed securities, as shown in the Generate and Report to Analytical Entity Description of Intellectual Property Securitization Fund 309 step.

Using the bond issue information, the program 300 then generates a pre-rating report and sends the pre-rating report to the Rating Institution 4, as shown in the Generate and Report to Rating Institution Pre-Rating Report 310 step. The pre-rating report contains all the results of the validity analysis, the focal market data, the capital structure of the securitization, the bond issue information as well as the results of any other analysis performed by the Banking Institution 3. Next, the program 300 generates and writes to the central database CD an MC Balance Sheet, Royalty Receivable Report, IPSF Statement and Surveillance Report in the Generate MC Balance Sheet, Royalty Receivable Report, IPSF Statement and Surveillance Report Step 311. The program 300 then receives, either as direct user input or by file transfer, from the Rating Institution 4 a rating for the asset backed securities generated using the information to valuate the asset backed securities, as shown in the Receive Bond Rating from the Rating Institution 312 step. The program 300 then generates and reports to the Banking Institution 3 a sales brochure for the sale of the asset backed securities that includes the rating from the rating institution along with the compendium report, as shown in the Generate and Report to Banking Institution Sales Brochure 313 step. The Banking Institution 3 then sells the asset backed securities to investors using the sales brochure. Finally, the program 300 generates an Intellectual Property Trust Certificate Chain of Title Report and writes it to the central database CD in the Generate Intellectual Property Trust Certificate Chain of Title Report 314 step.

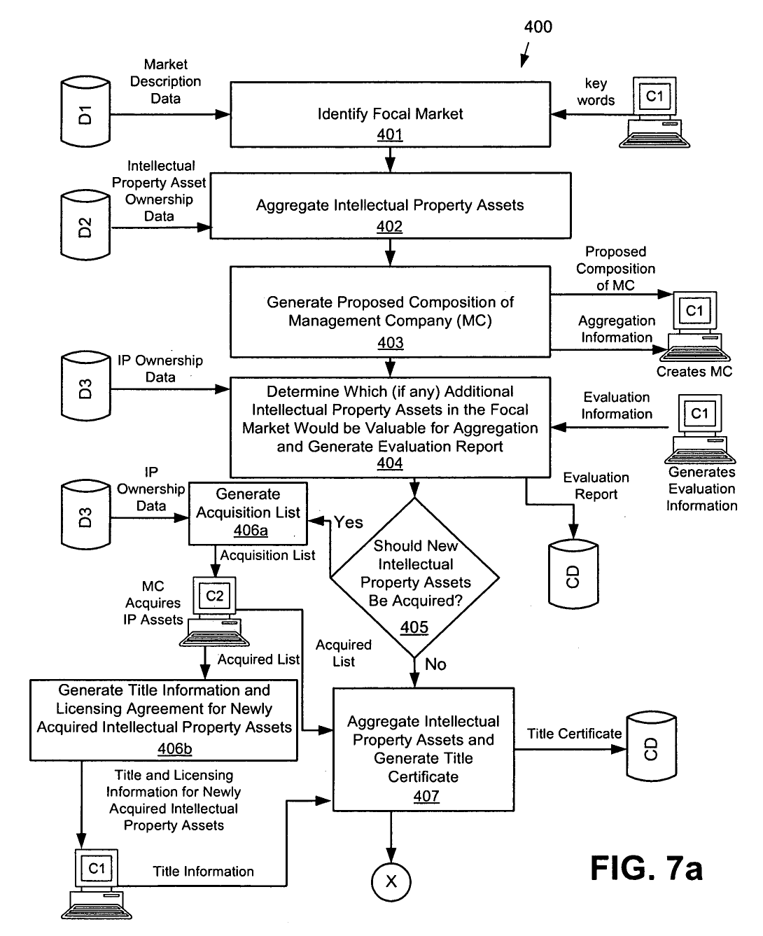

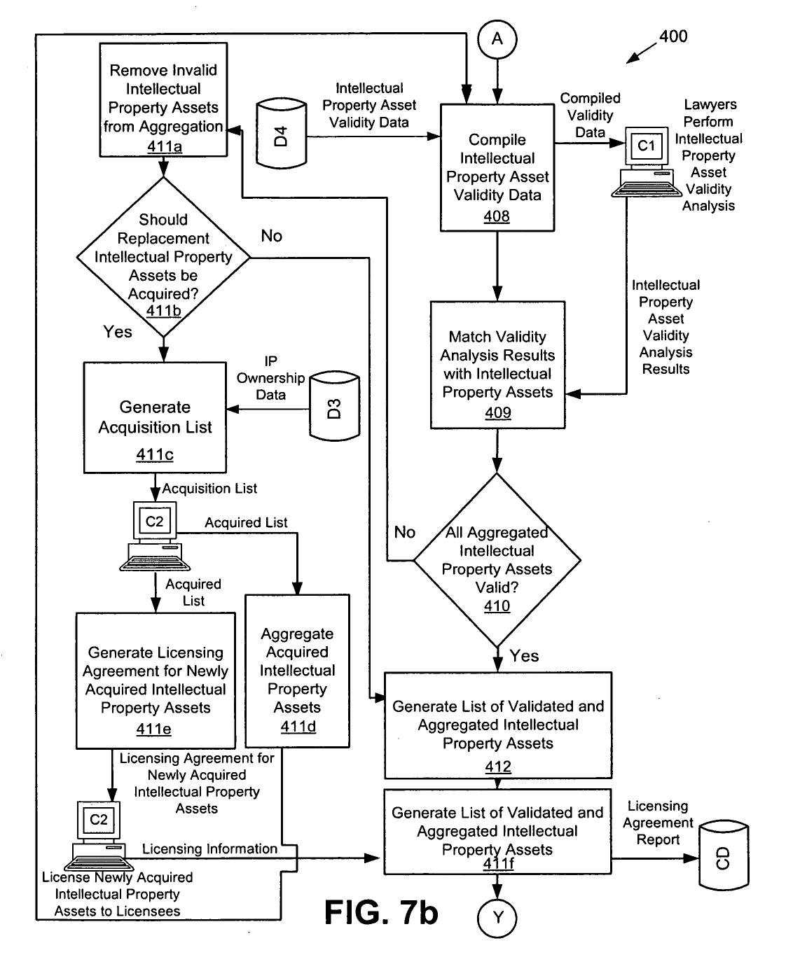

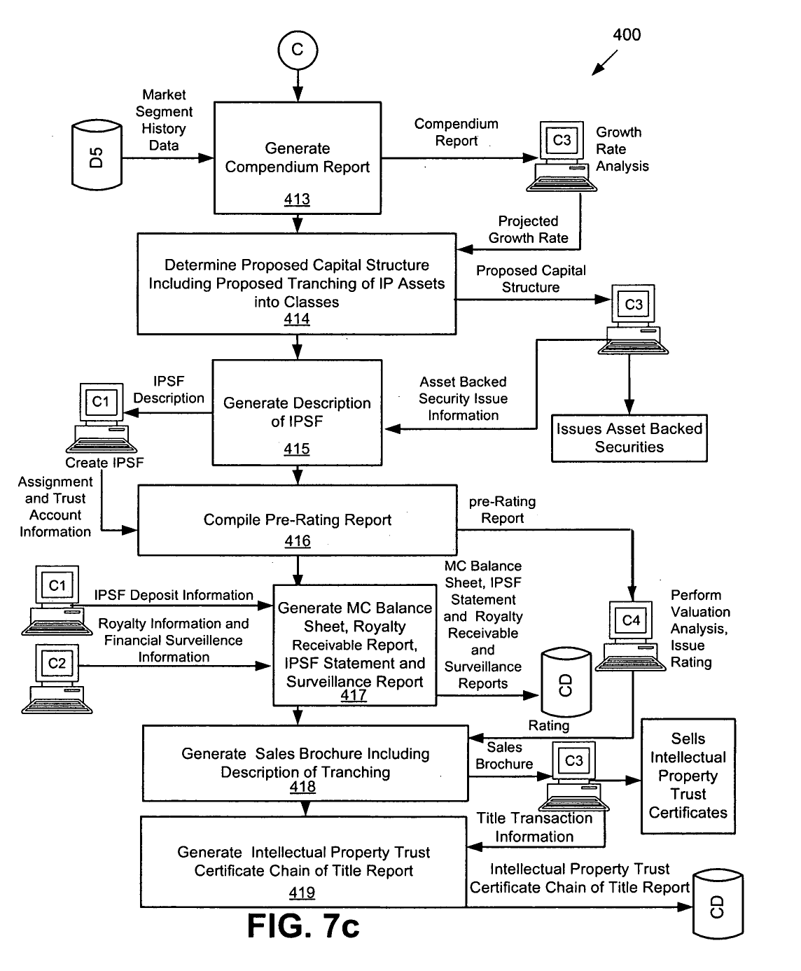

FIGS. 7a-7c together make up a single flowchart showing another computer program for assisting intellectual property asset securitization in an embodiment of the invention. FIG. 7a is the beginning of the operation of the program to intermediate point X, FIG. 7b shows the continuation of the program between intermediate points X and Y and FIG. 7c shows the continuation of the program from intermediate points Y to the stopping point.

The program 400 begins by identifying the focal market for the intellectual property asset aggregation, as shown in the Identify Focal Market 401 step. As shown in the Identify Focal Market 401 step of FIG. 7a, the program 400 receives, either as direct user input or by file transfer, key words from the Analytical Entity C1. The key words describe the business objectives Analytical Entity C1, the technology or industry of the intellectual property assets held by the Analytical Entity C1 or those to be acquired by the Analytical Entity C1. The program 200 then accesses a market segment database D1 that contains focal markets indexed by focal market descriptors and matches the key words to the focal market descriptors of the market segment database to identify a focal market for aggregating intellectual property assets into an intellectual property asset aggregation. Examples of focal markets include semiconductor technology if the Analytical Entity C1 holds intellectual property assets in DRAM technology, biomedical device technology if the Analytical Entity C1 holds intellectual property assets in medical diagnostic or implant devices, or alternative energy technology if the Analytical Entity C1 holds intellectual property assets in ethanol fuel production technologies or solar cell device technologies.

Next, the program 400 selects intellectual property assets relating to the focal market and aggregates them into an the intellectual property asset aggregation, as shown in the Aggregate Intellectual Property Assets 402 step. The program 400 also receives Evaluation Information from the Analytical Entity C1 and generates an Evaluation Report for the aggregation and writes it to the central database CD. As shown in FIG. 7a, the program 400 accesses an intellectual property asset ownership database D2 of intellectual property assets held by the analytical entity and indexed by focal market descriptors, matching the key words to the focal market descriptors of the intellectual property asset ownership database so as to generate a list of intellectual property assets held by the Analytical Entity C1 for aggregation.

The program 400 then generates and reports to the Analytical Entity C1 the intellectual property asset aggregation and a proposed structure for a Management Company for managing the securitization of intellectual property assets in the aggregation, as shown in the Generate Proposed Composition of Management Company (MC) 403 step. The proposed structure of the Management Company specifies the locale, board membership and recommended financial holdings of the company. The program 400 determines the structure of the Management Company using algorithm or algorithms that access a database (not shown) of information including unaffiliated and eligible professionals capable of serving on the board, potential financial holdings and advantageous locations for the location of the Management Company. After receiving the proposed structure of the Management Company from the program 200, the Analytical Entity C1 creates Management Company.

The program 400 subsequently determines if additional intellectual property assets should be added to the aggregation, as shown in the Determine Which (if any) Additional Intellectual Property Assets in the Focal Market Would be Valuable for Aggregation and Generate Evaluation Report 404 step. As shown in FIG. 7a, the program 400 accesses an intellectual property asset ownership database of intellectual property assets D3 held by a plurality of companies, not including the analytical entity, indexed by focal market descriptors. The program 400 then matches the key words describing the business objectives of Analytical Entity C1 to the focal market descriptors of the market segment database so as to determine whether new intellectual property assets should be acquired and aggregated. As shown in FIG. 7a, the program 400 determines whether new intellectual property assets should be acquired for the aggregation, in the Should New Assets Be Acquired 405 step.

As shown in FIG. 7a, the program 400 proceeds to the Generate Acquisition List 406a step if new assets are to be acquired. To generate the acquisition list, the program 400 accesses the intellectual property asset ownership database of intellectual property assets D3 held by a plurality of companies, not including the analytical entity, indexed by focal market descriptors and generates the Acquisition List of intellectual property assets to be acquired. The program 400 then reports the Acquisition List to the Management Company C2 which acquires the assets. Subsequently, the program 400 generates and reports to the Analytical Entity C1 a license agreement for the intellectual property assets on the list of acquired replacement intellectual property assets, as shown in the Generate Licensing Agreement for Newly Acquired Intellectual Property Assets 406b step. The program 400 then receives, either as direct user input or by file transfer, the Acquired List of acquired intellectual property assets from the Management Company C2, as shown in the Aggregate Intellectual Property Assets 407 step.

The program 400 then aggregates all intellectual property to be aggregated, as shown in the Aggregate Intellectual Property Assets and Generate Title Certificate 407 step, and subsequently submits the intellectual property assets in the aggregation for ownership validation, as shown in the Compile Intellectual Property Asset Validity Data 408 step in FIG. 7b. The program also receives Title Information from the Analytical Entity C1 and generates the Title Certificate and writes the generated Title Certificate to the central database CD (not shown) for Investor 13 access. Subsequently, the program 400 compiles validity data pertaining to the ownership of all intellectual property in the aggregation. The validity data can include any information relevant to the ownership and license of the intellectual property in the aggregation, such as titles, licensing agreements or relevant litigation or contracts. The program 200 reports to the Analytical Entity C1 the validity data so that a legal analysis of the validity of intellectual property assets in the aggregation can be performed by either the Analytical Entity C1 itself or by lawyers or other intellectual property professionals commissioned by the Analytical Entity C1.

The Analytical Entity C1 performs the validation analysis by using in-house legal counsel. Alternatively, the Analytical Entity C1 can perform the validation analysis by commissioning law firm, a consulting firm or other entity external to the Analytical Entity C1 and staffed with legal professionals with intellectual property specializations. In the validity analysis, the legal professionals examine the legal documents pertaining to both licensing and ownership of the intellectual property assets, the usefulness of the intellectual property assets for litigation and the time remaining until expiration of the intellectual property assets. In the validity analysis, the legal professions determine whether relevant licensing agreements are proper. This includes reviewing the documents for any errors or omissions, ensuring that each has been properly signed and filed and that proper approval for all relevant documents has been received. In the validity analysis, the legal professions also determine any outstanding issues not included explicitly in the licensing or ownership documents themselves that may also affect the validity of the intellectual property. Examples of outstanding issues that are examined by the legal professionals include any incomplete documentation, evidence that rightful inventors, authors or artists have been disincluded in the intellectual property ownership and any pending patent interference proceedings or litigation. In the validity analysis, the legal professions investigate these and other factors that can prevent the use of the intellectual property assets in litigation or the further sale or licensing of the intellectual property assets.

In the cases in which the intellectual property assets of the aggregation include patents with complex patent prosecution histories, the rightful ownership, inventorship and length of time until expiration of the intellectual property is investigated on a claim-by-claim basis. Inventorship of each claim is established individually to determine if licensing agreements and or sale of the portions of the patent that pertain to the claim are legally sound. Further, the term of each claim is established and rated against the claim's inherent usefulness for litigation purposes in the focal market of the aggregation. For patents, the legal professionals can also employ technical professionals including scientists, engineers and patent search professionals to survey both prior art relevant to the invention and as patents for similar technologies that have potentially overlapping claims.

Once the legal analysis is performed, the program 400 receives, either as direct user input or by file transfer, the validity analysis results from the Analytical Entity C1 and matches the validity analysis results with the intellectual property assets in the aggregation, as shown in the Match Validity Analysis Results with Intellectual Property Assets 409 step.

Next, the program 400 identifies any invalid intellectual property assets in the aggregation, as shown in the All Aggregated Intellectual Property Assets Valid 410 step. If invalid assets are found, the program 400 removes the invalid assets from the aggregation, as shown in the Remove Invalid Intellectual Property Assets From 411a step in FIG. 7b. Next, the program 400 determines whether the removed intellectual property assets is to be replaced, as shown in the Should Replacement Intellectual Property Assets be Acquired 411b step. Invalid assets are replaced if they made up a large portion of the assets in the aggregation or if the values of the invalid assets are particularly high relative to the average value of the intellectual property assets in the aggregation.

If the assets are to be replaced, the program 400 generates an Acquisition List of replacement intellectual property assets to be acquired, as shown in the Generate Acquisition List 411c step. As shown in FIG. 7b, the program 400 matches the key words describing the business objectives of the Analytical Entity C1 to the focal market descriptors of the intellectual property asset ownership database D3 so as to determine the Acquisition List and reports the Acquisition List to the Management Company C2. Subsequently, the program 400 receives, either as direct user input or by file transfer, an Acquired List of acquired replacement intellectual property assets from the Management Company C2, as shown in the Aggregate Acquired Intellectual Property Assets 411d step. Simultaneously, the program 400 generates and reports to the Analytical Entity C1 a license agreement for the intellectual property assets on the list of acquired replacement intellectual property assets, as shown in the Generate Licensing Agreement for Newly Acquired Intellectual Property Assets 411e step. The program 400 then re-initiates the validation process for the intellectual property asset aggregation, as shown in FIG. 7b by the arrow connecting the Aggregate Acquired Intellectual Property Assets 211d step with the Compile Intellectual Property Asset Validity Data 408 step. The validation process is re-imitated so that all newly acquired intellectual property assets are validated.

The program 400 then receives Licensing Information from the Management Company C2 and generates a Licensing Agreement Report and then generates a list of validated and aggregated intellectual property assets, as shown in the Generate List of Validated and Aggregated Intellectual Property Assets and Licensing Agreement Report 412 step. Subsequently, the program 400 generates a compendium report describing the intellectual property assets in the aggregation, as shown in FIG. 7c in the Generate Compendium Report 413 step. As shown in FIG. 7c, generating the compendium report includes accessing a market segment history database D5 containing information relating to the growth rate, market share held by the Analytical Entity C1 and revenue history of the focal market. The data from the validity analysis results, a summary of the growth rate history of the intellectual property assets held by the intellectual property asset Analytical Entity C1, a summary of the market share history held by the Analytical Entity C1, and a summary of the history of the focal market sector are all included in the compendium report sent by the program 400 to the Banking Institution C3 for determining a projected growth rate for the intellectual property asset aggregation, as shown in FIG. 7c.

Next, the program 400 receives, either as direct user input or by file transfer, from the Banking Institution C3 the projected growth rate for the aggregation, as shown in the Determine Proposed Capital Structure 414 step. The program 400 uses information regarding the intellectual property asset aggregation and the projected growth rate to generate a proposed capital structure for the securitization and reporting the proposed capital structure for the securitization of the aggregated intellectual property assets to the Banking Institution C3 for securitizing the aggregated intellectual property assets and issuing asset backed securities for the intellectual property asset securitization.

Next, the program 400 uses information regarding the intellectual property asset aggregation and the projected growth rate to generate a proposed capital structure for the securitization and reports the proposed capitalization structure to the Banking Institution 3, as shown in the Generate and Report to Banking Institution Proposed Capital Structure Including a Proposed Tranching of the IP into Classes 414 step.

The program 400 determines proposed tranching of the intellectual property assets into classes is based on their maturity. The program 400 first determines the number of classes and the payment timing for those classes, where the payment timing is the timing of payments to the investor. The tranching will be such that certain classes will pay cash flows to investors in the short term, while other classes will pay greater cash flows to the investors in the long term. The program 400 determines the payment timing by analyzing data from similar asset securitizations by accessing a database of Recent Securitization Capital Structure Data D6. For example, the program 400 can propose tranching the intellectual property assets of the aggregation into classes that are identical to those used in one recent intellectual property asset securitization, the data for which is stored in the database of Recent Securitization Capital Structure Data D6. Alternatively, the program 400 can propose to tranch the intellectual property assets of the aggregation into classes based on averages of payment timing schemes for a number of recent intellectual property asset securitizations stored in the database of Recent Securitization Capital Structure Data D6. The program 400 then determines the pricing for each tranch, generally inversely related to the timing of payments by first analyzing the pricing data, stored in the database of Recent Securitization Capital Structure Data D6, from similar securitizations and then interpolating between those data to find appropriate pricing to match the payment timing. For example, the program 400 can determine the price of each tranch by matching payment timing to tranches in one recent intellectual property asset securitization. Alternatively, the program 400 can determine the price of each tranch by averaging prices for tranches matching the payment timing of the tranch of one recent intellectual property asset securitization, stored in the database of Recent Securitization Capital Structure Data D6, by tranching the intellectual property assets of the intellectual property asset aggregation into classes based on averages of payment timing schemes, stored in the database of Recent Securitization Capital Structure Data D6, for a number of recent intellectual property asset securitization.

Subsequent to receiving the proposed capital structure, including the tranching of the intellectual property assets into classes, from the program 400, the Banking Institution 3, decides whether to implement the proposed capital structure, then creates and issues asset backed securities backed by the intellectual property asset aggregation. The Banking Institution 3 can decide to utilize the tranching classes proposed by the program, or develop another tranching scheme. If the Banking Institution 3 develops another tranching scheme, the tranching scheme developed by the Banking Institution 3 can be based on the tranching scheme proposed by the program 400.

The program 400 then uses the bond issue information to generate and send to the Rating Institution C4 a pre-rating report, as shown in the Compile Pre-Rating Report 416 step. The pre-rating report consists of the compendium report, projected growth rate and bond issue information. This report can contain all the results of the validity analysis, the focal market data, the capital structure of the securitization, the bond issue information and the results of any other analysis performed by the Banking Institution C3. As shown in FIG. 7c, the program 400 then reports the pre-rating report to a Rating Institution C4 that uses the pre-rating report to rate the asset backed securities for the intellectual property asset securitization. Subsequently, the program 400 generates a balance sheet for the Management Company, as shown in the Generate MC Balance Sheet 417 step. Subsequently, the program 400 receives IPSF Deposit Information from the Analytical Entity C1, receives Royalty Information and Financial Surveillance Information from the Management Company C2 and generates and writes to the central database CD a balance sheet for the Management Company, a Royalty Receivable Report, an IPSF Statement and a Surveillance Report as shown in the Generate MC Balance Sheet , Royalty Receivable Report, IPSF Statement and Surveillance Report 417 step.

As shown in FIG. 7c, the Rating Institution. C4 uses the information in the pre-rating report to valuate the asset backed securities and issue a rating. The program 400 then receives, either as direct user input or by file transfer, the rating from the Rating Institution C4. The program 400 then generates and reports to the Banking Institution C3 a sales brochure for the selling of the asset backed securities that includes the rating from the rating institution along with the compendium report, as shown in the Generate Sales Brochure 418 step. The sales brochure includes: the balance sheet for the Management Company generated in step 417, a description of the Intellectual Property Securitization Fund 5, securitization balance sheet, rating and projected growth rate. As shown in FIG. 7c, the Banking Institution C3 then sells the asset backed securities to investors using the sales brochure. Subsequently, as shown in FIG. 7c, the program 400 receives Title Transaction Information from the Banking Institution C3 and generates and writes to the central database CD a Intellectual Property Trust Certificate Chain of Title Report as shown in the Generate Intellectual Property Trust Certificate Chain of Title Report 419 step.

It will be apparent to those skilled in the art that various modifications and variations can be made in the computer assisted process for providing liquidity to an enterprise by utilizing intellectual property assets of embodiments of the invention without departing from the spirit or scope of the invention. Thus, it is intended that embodiments of the invention cover the modifications and variations of this invention provided within the scope of the appended claims and their equivalents.

What is claimed is:

1. A computer program storing computer instructions therein for instructing a computer to perform analytical steps for the centralized public sale of intellectual property trust certificates issuing from the securitization of intellectual property assets, the securitization initiated by an analytical entity and managed by a management company, the securities sold as intellectual property trust certificates to an investor having access to a central database by a banking institution and the program comprising: a recording medium readable by the computer; and the computer instructions stored on said recording medium instructing the computer to perform the processes including:
reporting to the central database an evaluation report of the aggregation for soliciting investment;
reporting to the central database a title certificate;
reporting to the central database a licensing agreement report for the aggregation for licensing intellectual property assets to licensees;
reporting to the central database a description of an intellectual property securitization fund for guaranteeing the intellectual property trust certificates;
reporting to the central database a royalties receivable report for the aggregation;
reporting to the central database an intellectual property securitization fund statement;
reporting to the central database a surveillance report; and
reporting to the central database an intellectual property trust certificate chain of title report.

2. A computer program storing computer instructions therein for instructing a computer to perform analytical steps for the centralized public sale of intellectual property trust certificates issuing from the securitization of intellectual property assets, the securitization initiated by an analytical entity and managed by a management company, the securities sold as intellectual property trust certificates to an investor having access to a central database by a banking institution and the program comprising: a recording medium readable by the computer; and the computer instructions stored on said recording medium instructing the computer to perform the processes including:
identifying a focal market;
aggregating intellectual property assets into an intellectual property asset aggregation relating to a focal market;
reporting to the analytical entity a proposed structure for a management company for managing the securitization of intellectual property assets;
validating the intellectual property assets of the intellectual property asset aggregation;
reporting to the central database an evaluation report of the aggregation for soliciting investment;
reporting to the central database a title certificate;
reporting to the central database a licensing agreement report for the aggregation for licensing intellectual property assets to licensees;
reporting a compendium report to a banking institution for determining a projected growth rate;
receiving a projected growth rate from the banking institution;
reporting to the banking institution a proposed capital structure for the intellectual property asset securitization and issuing of intellectual property trust certificates;
receiving from the banking institution information regarding the issuing of intellectual property trust certificates;
reporting to the analytical entity a description of an intellectual property securitization fund for guaranteeing the intellectual property trust certificates;
reporting to a rating institution a pre-rating report for rating the intellectual property trust certificates;
reporting to the central database a management company balance sheet;
reporting to the central database a royalty receivable report;
reporting to the central database an intellectual property security fund statement;
reporting to the central database a surveillance report;
receiving a bond rating from the rating institution;
reporting to the banking institution a sales brochure for selling the intellectual property trust certificates; and
reporting to the central database an intellectual property trust certificate chain of title report.

3. The computer program of claim 2, wherein the identifying the focal market includes:
receiving key words from the analytical entity describing the business objectives of an analytical entity;
accessing a market segment database of focal markets indexed by focal market descriptors; and
matching the key words to the focal market descriptors of the market segment database so as to identify a focal market for aggregating intellectual property assets into an intellectual property asset aggregation.

4. The computer program of claim 2, wherein the reporting a compendium report to a banking institution for determining a projected growth rate includes:
accessing a market segment history database containing information relating to the growth rate, market share held by the analytical entity and revenue history of the focal market;
generating a compendium report containing:
the validity analysis results;
a summary of the growth rate history of the intellectual property assets held by the analytical entity;
a summary of the market share history held by the analytical entity; and
a summary of the history of the focal market sector; and
reporting the compendium report to the banking institution that uses the compendium report to determine a projected growth rate for the intellectual property asset aggregation fund.

5. The computer program of claim 2, wherein the aggregating intellectual property assets into an intellectual property asset aggregation includes:
accessing an intellectual property asset ownership database of intellectual property assets held by the analytical entity and indexed by focal market descriptors; and
matching the key words to the focal market descriptors of the intellectual property asset ownership database so as to generate a list of intellectual property assets held by the analytical entity for aggregation.

6. The computer program of claim 5, wherein the aggregating intellectual property assets into an intellectual property asset aggregation includes:
accessing an intellectual property asset ownership database of intellectual property assets held by a plurality of companies, not including the analytical entity, indexed by focal market descriptors;
matching the key words describing the business objectives of the analytical entity to the focal market descriptors of the market segment database so as to determine a list of intellectual property assets to be acquired and aggregated;
reporting to the management company the list of intellectual property assets to be acquired;
receiving from the management company a list of acquired replacement intellectual property assets;
generating a license agreement for the intellectual property assets on the list of acquired replacement intellectual property assets; and
reporting to the analytical entity the license agreement for the acquired replacement intellectual property assets.

7. The computer program of claim 2, wherein the validating the intellectual property assets of the intellectual property asset aggregation includes:
accessing a intellectual property validity database containing information regarding the ownership of the intellectual property;
compiling validity data for the list of intellectual property assets for aggregation in the intellectual property securitization fund;
reporting to the analytical entity the validity data for the list of intellectual property assets for aggregation in the intellectual property securitization fund for a legal analysis of the validity of intellectual property assets in the list of intellectual property assets for aggregation in the intellectual property securitization fund;
receiving from the analytical entity the results of the legal analysis of the validity data;
matching the validity analysis results with the intellectual property assets in the list of intellectual property assets for aggregation in the intellectual property securitization fund;
identifying any invalid intellectual property assets in the list of intellectual property assets for aggregation in the intellectual property securitization fund; and
removing any invalid intellectual property assets from the list of intellectual property assets for aggregation in the intellectual property securitization fund.

8. The computer program of claim 2, wherein the reporting to the banking institution a proposed capital structure for the intellectual property asset securitization and issuing of intellectual property trust certificates includes:
generating a proposed capital structure for the securitization of the aggregated intellectual property assets;
reporting the proposed capital structure for the securitization of the aggregated intellectual property assets to the banking institution for the securitizing the aggregated intellectual property assets and issuing intellectual property trust certificates for the intellectual property asset securitization.

9. The computer program of claim 2, wherein the reporting to the analytical entity a description of an intellectual property securitization fund for guaranteeing the intellectual property trust certificates includes:
generating a description of an intellectual property securitization fund for guaranteeing the intellectual property trust certificates; and
reporting to the analytical entity the description of an intellectual property securitization fund for guaranteeing the intellectual property trust certificates.

10. The computer program of claim 2, wherein the reporting to a rating institution a pre-rating report for rating the intellectual property trust certificates includes:
compiling the compendium report, projected growth rate and bond issue information into a pre-Rating Report; and
reporting to a rating institution the pre-rating report that the rating institution uses to rate the intellectual property trust certificates for the intellectual property asset securitization.

11. The computer program of claim 2, wherein the reporting to the banking institution a sales brochure for selling the intellectual property trust certificates includes:
generating a sales brochure including a description of the intellectual property securitization fund, securitization balance sheet, rating and projected growth rate; and
reporting to the banking institution the sales brochure for selling the intellectual property trust certificates.

12. A computer program storing computer instructions therein for instructing a computer to perform analytical steps for the centralized public sale of intellectual property trust certificates issuing from the securitization of intellectual property assets, the securitization initiated by an analytical entity and managed by a management company, the securities sold as intellectual property trust certificates to an investor having access to a central database by a banking institution and the program comprising: a recording medium readable by the computer; and the computer instructions stored on said recording medium instructing the computer to perform the processes including:
identifying a focal market;
aggregating intellectual property assets into an intellectual property asset aggregation relating to the focal market;
reporting to the analytical entity a proposed structure for a management company for managing the securitization of intellectual property assets;
validating the intellectual property assets of the intellectual property asset aggregation;
reporting to the central database an evaluation report of the aggregation for soliciting investment;
reporting to the central database a title certificate;
reporting to the central database a licensing agreement report for the aggregation for licensing intellectual property assets to licensees;
reporting a compendium report to a banking institution for determining a projected growth rate;
receiving a projected growth rate from the banking institution;
reporting to the banking institution a proposed capital structure, including a proposed tranching of the intellectual property assets into classes, for the intellectual property asset securitization and issuing of intellectual property trust certificates;
receiving from the banking institution information regarding the issuing of intellectual property trust certificates and the tranching of those intellectual property trust certificates into classes;
reporting to the analytical entity a description of an intellectual property securitization fund for guaranteeing the intellectual property trust certificates;
reporting to a rating institution a pre-rating report for rating the intellectual property trust certificates;
reporting to the central database a management company balance sheet;
reporting to the central database a royalty receivable report;
reporting to the central database an intellectual property security fund statement;
reporting to the central database a surveillance report;
receiving a bond rating from the rating institution;
reporting to the banking institution a sales brochure for selling the intellectual property trust certificates including the tranching of the intellectual property assets into classes; and
reporting to the central database an intellectual property trust certificate chain of title report.

13. The computer program of claim 12, wherein the identifying the focal market includes:
receiving key words from the analytical entity describing the business objectives of an analytical entity;
accessing a market segment database of focal markets indexed by focal market descriptors; and
matching the key words to the focal market descriptors of the market segment database so as to identify a focal market for aggregating intellectual property assets into an intellectual property asset aggregation.

14. The computer program of claim 12, wherein the reporting a compendium report to a banking institution for determining a projected growth rate includes:
accessing a market segment history database containing information relating to the growth rate, market share held by the analytical entity and revenue history of the focal market;
generating a compendium report containing:
the validity analysis results;
a summary of the growth rate history of the intellectual property assets held by the analytical entity;
a summary of the market share history held by the analytical entity; and
a summary of the history of the focal market sector; and
reporting the compendium report to the banking institution that uses the compendium report to determine a projected growth rate for the intellectual property asset aggregation fund.

15. The computer program of claim 12, wherein the aggregating intellectual property assets into an intellectual property asset aggregation includes:
accessing an intellectual property asset ownership database of intellectual property assets held by the analytical entity and indexed by focal market descriptors; and
matching the key words to the focal market descriptors of the intellectual property asset ownership database so as to generate a list of intellectual property assets held by the analytical entity for aggregation.

16. The computer program of claim 15, wherein the aggregating intellectual property assets into an intellectual property asset aggregation includes:
accessing an intellectual property asset ownership database of intellectual property assets held by a plurality of companies, not including the analytical entity, indexed by focal market descriptors;
matching the key words describing the business objectives of the analytical entity to the focal market descriptors of the market segment database so as to determine a list of intellectual property assets to be acquired and aggregated;
reporting to the management company the list of intellectual property assets to be acquired;
receiving from the management company a list of acquired replacement intellectual property assets;
generating a license agreement for the intellectual property assets on the list of acquired replacement intellectual property assets; and
reporting to the analytical entity the license agreement for the acquired replacement intellectual property assets,

17. The computer program of claim 12, wherein the validating the intellectual property assets of the intellectual property asset aggregation includes:
accessing a intellectual property validity database containing information regarding the ownership of the intellectual property;
compiling validity data for the list of intellectual property assets for aggregation in the intellectual property securitization fund;
reporting to the analytical entity the validity data for the list of intellectual property assets for aggregation in the intellectual property securitization fund for a legal analysis of the validity of intellectual property assets in the list of intellectual property assets for aggregation in the intellectual property securitization fund;
receiving from the analytical entity the results of the legal analysis of the validity data;
matching the validity analysis results with the intellectual property assets in the list of intellectual property assets for aggregation in the intellectual property securitization fund;
identifying any invalid intellectual property assets in the list of intellectual property assets for aggregation in the intellectual property securitization fund; and
removing any invalid intellectual property assets from the list of intellectual property assets for aggregation in the intellectual property securitization fund.

18. The computer program of claim 12, wherein the reporting to the banking institution a proposed capital structure, including a proposed tranching of the intellectual property assets into classes, for the intellectual property asset securitization and issuing of intellectual property trust certificates includes:
generating a proposed capital structure for the securitization of the aggregated intellectual property assets;
generating a proposed tranching of the aggregated intellectual property assets based on the maturities of the intellectual property assets;
generating a proposed pricing scheme for the intellectual property trust certificate based on the tranching of the aggregated intellectual property; and
reporting the proposed capital structure for the securitization of the aggregated intellectual property assets to the banking institution for the securitizing the aggregated intellectual property assets and issuing intellectual property trust certificates for the intellectual property asset securitization.

19. The computer program of claim 12, wherein the reporting to the analytical entity a description of an intellectual property securitization fund for guaranteeing the intellectual property trust certificates includes:
generating a description of an intellectual property securitization fund and using the intellectual property securitization fund to guarantee the intellectual property trust certificates; and
reporting to the analytical entity the description of an intellectual property securitization fund and use of the intellectual property securitization fund to guarantee the intellectual property trust certificates for creating an intellectual property securitization fund and guaranteeing the intellectual property trust certificates.

20. The computer program of claim 12, wherein the reporting to a rating institution a pre-rating report for rating the intellectual property trust certificates includes:
compiling the compendium report, projected growth rate and bond issue information into a pre-Rating Report; and
reporting to a rating institution the pre-rating report that the rating institution uses to rate the intellectual property trust certificates for the intellectual property asset securitization.

21. The computer program of claim 12, wherein the reporting to the banking institution a sales brochure for selling the intellectual property trust certificates including the tranching of the intellectual property assets into classes includes:
generating a sales brochure including a description of the intellectual property securitization fund, securitization balance sheet, rating and projected growth rate; and
reporting to the banking institution the sales brochure for selling the intellectual property trust certificates.
